(19) United States
(12) Patent Application Publication
(10) Pub. No.: US 2009/0280349 A1
(43) Pub. Date: Nov. 12, 2009

(54) Multipart subassembly composed of metallic parts, and method for the production thereof

(76) Inventors: Markus Bittendorfer, Altmunster (AT); Roland Heiml, Vocklamarkt (AT)

Correspondence Address: COLLARD & ROE, P.C., 1077 NORTHERN BOULEVARD, ROSLYN, NY, 11576, US

(21) Appl. No.: 11/658,442

(22) PCT Filed: Jul. 13, 2005
(86) PCT No.: PCT/AT2005/000265

§ 371 Date: Apr. 6, 2009

(30) Foreign Application Priority Data
Jul. 27, 2004 (AT) 1278/2004

(51) Int. Cl. B32B 15/01; B23K 15/00

(52) U.S. Cl. 428/594; 219/121.14; 219/121.13

(57) ABSTRACT

The invention relates to an assembly (1) and a method for producing the latter, with a first and second part (2, 3), the first part (2, 3) of which is cold formed and the parts (2, 3) with parallel surface parts (20, 21) and mounting surfaces running at an angle to the latter are provided for arranging them relative to one another without a gap and are joined together at the joint (16) by a weld (17) produced by beam welding. The surface parts (20, 21) are arranged offset relative to one another by an offset (19). One of the parts (2, 3) comprises a mounting projection (6), which forms the mounting surface of the first part (2). The parts (2, 3) are positioned relative to one another so that the second part (3) forms the joint (16) with the first part (2) in the section of the first part (2) at which the dislocation density of the base material is lower than the dislocation density of the joint in a deformation area (18) on the first part (2) produced by cold forming.

The invention relates to an assembly comprising at least two metal parts joined together by means of beam welding, a method for the production thereof and a welding system, as described in the preambles of claims 1, 2, 11, 41 and 49.

From DE 196 36 212 C1 and DE 199 48 013 A1 it is known to place two metal parts of different thicknesses against one another with their edges to be welded together in a butt joint and to join them together by a weld produced by beam welding, in particular laser beam welding, along the joint formed by the edges lying essentially next to one another with no gaps. The welded together sheet metal parts are used as a so-called deep-drawing board, which in a subsequent deep-drawing stage are shaped for example into a vehicle body sheet with areas of varying thickness. In order to achieve unproblematic and tool-protecting behaviour in the shaping tool in the subsequent deep-drawing of such boards, it is important for the transition from the thick to the thin sheet metal part in the region of the joint to be as smooth and even as possible. Furthermore, after welding there should be no abrupt narrowing of cross section in the region of the joint, as during the deep-drawing there are increased tensioning peaks which could cause the board to crack. To make sure that the transition from the thick to the thin metal part in the region of the joint is as smooth and even as possible it is ensured that sufficient material is melted off the thickener metal part, which means that the jump in thickness is vital for the benefit of the weld connection. The result is an increased requirement for material for the production of such deep-drawing boards so that the demand for economic production of an assembly for a vehicle body part cannot be met.

Furthermore, from DE 34 07 770 A1 a connection between two metal sheet parts of a fuel container for motor vehicles is known, which are in the form of half shells, each having a laterally curved, peripheral flange. The flanges of the two half-shells are designed to be congruent. With containers of this kind a very high degree of leak-tightness is required. Thus a fuel container has to be absolutely gastight in order to prevent the undesirable leakage of petrol vapour, e.g. when the fuel container is heated. In addition, in one of the two half shells a bead-like depression is made and the laser beam is guided along the bead-like depression. The bead-like depression in the first half shell is pointed in the direction of the second half shell and has a flat mounting surface on which the first half shell lies on the sheet flange of the second half shell with no gaps. The axis of the laser beam guided along the bead-like depression is aligned perpendicular to the mounting surfaces, so that the two half shells are welded on their sheet metal flanges by means of an overlap weld on the entire circumference of the container. The two half shells must in this case be positioned precisely relative to one another in a plane parallel to the mounting surface, as even a slight misalignment of one of the two shells in the plane can mean that the overlap weld cannot be formed correctly. In addition, the joint cross section of the overlap weld is dependent on the weld width, so that the advantages otherwise often made use of in laser welds of a low influx of heat on the parts to be welded and the low distortion of the parts to be welded cannot be exploited, and even if the bead-like depression is produced with high precision the increased, heat-related distortion has a negative effect on the quality of the welding connection. Moreover, with overlap welds there is an unfavourable flow of force.

From EP 0 200 997 B1 a welding connection between two metal sheet parts is known, wherein a first metal part forms an optically smooth outer surface and is flanged by 180° on its rear surface and the second metal sheet part is laid on the flanged edge, wherein the metal parts are welded together by a fillet weld on the joint formed between the flanged edge of the first sheet metal part and a front edge of the second sheet metal part.

A welding connection between two metal parts is known from DE 101 39 082 A1, in which the facing edge areas of both metal parts are bend by 180° and arranged in parallel spaced apart from one another, wherein the edge areas lie against one another by means of impressions formed spaced apart in at least one of the edge areas, and the metal parts are connected in the area of these impressions on the front side by means of laser welding.

DE 34 07 770 A1 and DE 101 39 082 A1 have the disadvantage that the weld is placed in those sections of the metal parts at which there is an increased dislocation density or increased hardness. This results in the region around the weld to the appearance of ageing caused by sub-microscopic depositions on the sliding planes, which block the dislocation movements or make them more difficult, which can lead to considerable embrittlement. In particular N but also O, C and H diffuse preferably into these dislocation areas and largely block the dislocation movement. The result of this is a reduction in toughness and an embrittlement of the material of the metal parts.

Furthermore, from U.S. Pat. No. 6,379,392 B1 a wire stent is known that can be implanted into a human body, which is designed to be approximately tubular and has a skeleton frame with a plurality of straight sections contacting one another without a gap. Two contacting sections form a joint and are connected together by welds directed along the joint. During the melt welding the base material of the sections are melted on the joint, whereby the sections lying against one another can only be welded together with a lower level of positioning precision.

Lastly, from DE 102 06 887 A1 a method is known for laser welding sheet metal parts, which are tensioned without flange, wherein the tensioning is controlled by the positioning and/or force depending on the comparison of the desired/actual dimensions and/or surfaces of the welded sheet metal part. The sheet parts are pressed together on their welding flanges and welded together there.

The objective of the invention is to create a multipart assembly and a method, which despite having imprecise, individual parts is characterised by its high dimensional precision, has good strength properties and makes possible a welding connection of the highest quality, and which permits greater correction of individual parts for the assembly and the simple, inexpensive production thereof.

Furthermore, it is the objective of the invention to create a welding system, by means of which a multipart assembly can be produced as easily and inexpensively as possible with a high degree of measurement precision.

The objective of the invention is achieved by means of the features described in the characterising part of claim 1. The advantages here are that only the mounting surfaces of the mounting projection formed on at least one of the parts have to be produced with high precision, in order to be able to produce an assembly with low levels of dimensional inaccuracies. Due to the high precision of the mounting surfaces an exact joining gap is formed at the joint between the parts, which is filled even with beam welding, in particular laser welding, without additional material by the melting base material of the parts, so that now the weld can also be formed by a mechanically highly stressable fillet weld or square-groove weld (butt weld) and a reliable joint connection is created corresponding to the requirements for strength. In addition, the offset of the surface parts of the parts to form a step on the joint has proved advantageous as the weld is set back relative to the surface parts and a weld projection is avoided on the surface parts. Thus said surface parts can meet the functional requirements made of them, such as for example sliding an additional component onto one of the surface parts of the component. Moreover, the step does not reduce the strength of the assembly, as on the one hand after welding there is no abrupt change in cross section at the joint between the parts, and therefore with mechanical loading on the component an optimal progression of force over the joint connection is possible, and on the other hand the advantageous effect of material hardening in the weld can be made use of to absorb stress peaks in the case of mechanical loading on the assembly. By means of this increase in strength of the weld the formation of cracks in the weld is reliably avoided, even when an overlap width defining the maximum possible depth of the weld between the parts is smaller than the thickness of one of the parts. It is also an advantage that the appearance of ageing caused by submicroscopic deposits on the sliding planes is avoided and in this way the potential formation of cracks and consequently brittleness caused by the action of external forces can be prevented. Therefore, there is no need for a heat treatment to follow the welding, such as for example a recovery or annealing process, which means that there is a reduction in the manufacturing time or manufacturing cost of the assemblies. Moreover, it is also an advantage if the welding takes place outside the deformation area, as no tempering effect occurs in the heat influx zone of the weld by recrystallisation or recovery, caused by the welding heat. The shaped area of the part would thus be weakened, whereby the yield strength, hardness and tensile strength would become lower and the positive effect of the previously conducted cold forming, which is advantageous especially for thin-walled parts of low weight in respect of strength and stability and thus advantageous for the deformation resistance of the part, would be neutralised.

The objective of the invention is also achieved however by means of the features described in the characterising part of claim 2. The advantages here are that only the mounting surfaces of the parts have to be produced with high precision to produce an assembly with a low amount of dimensional inaccuracies. Because of the high precision of the mounting surfaces an exact joining gap is created at the joint between the parts, which is filled even with beam welding, in particular laser welding, without additional material by the melting base material of the parts, so that the weld can also be formed by a mechanically highly stressable fillet weld or square-groove weld and a reliable joint connection is created, thus meeting the requirements for strength.

The embodiment according to claim 3 is advantageous, as by means of the additional positioning surface an exact positioning of the parts to be welded relative to one other is possible, so that the precision of the assembly is improved further. The positioning surface is designed in one embodiment together with the mounting surface on a mounting and positioning projection. However, the positioning surface can be formed by a positioning projection and the mounting surface by a mounting projection, the mounting and positioning projection being arranged separately from one another.

Advantageous embodiments of the assembly according to the invention are described in claims 4 to 9. The individual parts are all produced with their final dimensions before they are joined together to form the assembly so that there is no need to rework the assembly afterwards, and due to its particularly economical manufacture it is used in many different technical areas, in particular in motor vehicle technology, such as for example in engine parts, wheel suspension, steering boxes and the like

According to claim 10 the appearance of ageing and the possible crack formation and brittleness resulting therefrom can be prevented under the action of external forces. The weld lies in a section of the assembly that is not critical for strength properties, so that even with thermal joining there are no strength-relevant impairments to the joints of the parts.

The objective of the invention is also achieved however by the features described in the characterising part of claim 11. The advantages are that even with greater tolerances of the mounting surface of the parts to be welded together without additional materials the tolerances are compensated and a welding connection of the highest quality can be produced in particular with respect to strength requirements. In addition, a simpler and more economic manufacture of the parts and the welding connection is possible. Now parts can be welded together which due to the total profile height on the mounting surfaces form a joint, at which otherwise welding would only be possible with additional material.

The designs according to claims 12 and 13 are also advantageous, whereby the parts can be positioned or aligned exactly in relation to one another and can reliably abut against one another without a gap.

According to developments of the invention according to claims 14 to 17 by means of the base material melted from the welding bar a joint can be filled perfectly in an amount of between 5% and 10% of the thickness. Thus separating methods can be used for producing the mounting surfaces, which otherwise can only be used when the mounting surfaces are worked subsequently or the welding is carried out using an additional material. For example, a draw-in radius occurring during stamping can be compensated.

The design according to claim 18 is also advantageous, wherein a particularly simple manufacture is made possible in one piece with the part cut for example from a piece of sheet metal.

According to claim 19 it is achieved that the internal welding stresses in the parts caused by the thermal effect of the laser beam can be kept low and the minimal distortion caused thereby has no effect on the precision of the dimensions of the assembly. Although the distortion during laser welding is relatively low, by optimising the sequence of the welds to be placed on several joints, the internal welding stresses are compensated in the parts. The embodiment according to claim 20 is advantageous as only over a small area of the surface part does the mounting and positioning projection need to be produced with high precision, whereas the adjoining, remaining area of the surface part can be produced with conventional manufacturing precision. In this way the cutting tools, in particular the stamping tools or shaping tools, in particular forging tools, can be designed according to the requirements of precision, whereby the costs of acquiring such tools can be reduced.

According to claim 21 the free positioning of two parts relative to one another is possible in a plane parallel to the mounting surface.

The embodiment according to claim 22 enables welding at any points on the joint.

According to claim 23 a particularly economical manufacture of the parts is made possible.

The embodiment according to claim 24 is also advantageous, wherein on the one hand by means of the positioning projection an exact positioning of the parts relative to one another is possible and on the other hand via the welding connection on the mounting projection a highly stressable construction is created, as the weld extends over the entire length of the mounting projection and its start and end sections are rounded.

The developments according to claim 25 and 26 are advantageous, as the bearings pressed into the sleeve against the mounting and positioning surfaces formed for welding and positioning of the parts with high precision are used simultaneously for supporting the bearing, so that standard bearings can be used. In this way a simple and precise bearing of a shaft on the assembly is ensured. In addition beam welding permits a very broad selection of materials to be welded. Thus it is possible for example to weld hardened steel without the formation of cracks. This makes it possible to weld directly the outer and inner ring of a bearing which usually consists of hardened steel. The described sleeve in this case forms the outer or inner ring of the bearing.

By means of the development according to claim 27 the dimensional imprecisions on the assembly can be reduced further.

Advantageous dimensions of the mounting and/or positioning projection are described in claims 28 and 29. By means of this mounting and/or positioning projection an exact mounting and positioning of the two parts to be welded together is achieved, whereby the weld can also be produced with high quality.

Different advantageous arrangements of two parts to be welded together are described in claims 30 to 32.

According to claims 33, 36, 37, 39 and 40 on the one hand the internal welding stresses can be kept low in the parts and on the other hand the end sections of the welds lie in a section of the assembly that is not critical for the strength properties, whereas the start sections of the welds lie in those sections of the assembly through which the main direction of stress runs. However, if the end sections of the welds overlap at a common meeting point the meeting point can also lie in that section of the assembly, through which the main direction of stress runs or high stresses occur.

The embodiments according to claims 34 and 35 are also advantageous, as the notches caused by the process in the end section of the welds (tapering of the weld cross section) coincide in a common section of the assembly, so that the assembly can be stressed with high mechanical stresses by wide parts.

According to claim 38 a simple manufacture of the welds on two separate joints is achieved.

The objective of the invention is also achieved however by the measures and features described in the characterising part of claims 41 and 49. The advantages are that with the clamping tool not only is the corresponding part fixed, as known from the prior art, but even in the case of deviations in the shape of this part it functions as a shaping or correcting tool. In this way the number of handling procedures for producing the assembly can be reduced to a minimum. If a deviation is shape is detected on one or both of the parts to be welded together, by means of the already provided clamping tool the incorrect shape of this part is corrected and only afterwards welded to the second part. As imprecisions in the part subjected to stages of shaping and/or shaping do not have any effect on the overall precision of the assembly, the demands for the manufacturing precision of both the shaped part and the other part are reduced. Thus corrected assemblies are produced from imprecise individual parts which considerably improve their further processing.

The measures and features according to claims 42 to 46 and 50 to 53 are also advantageous, whereby a control loop is closed in a fully automatic welding system and even during the production of the assembly a monitoring function can be performed with the purpose of quality control.

According to claim 47 it is an advantage that the part is shaped past its elasticity limit and has the greatest degree of geometric precision.

Lastly, the measure according to claim 48 is also advantageous as the part is shaped within its elasticity limit and in this way internal welding stresses in the part can be reduced or removed.

The invention is explained in more detail in the following by way of the exemplary embodiments represented in the drawings.

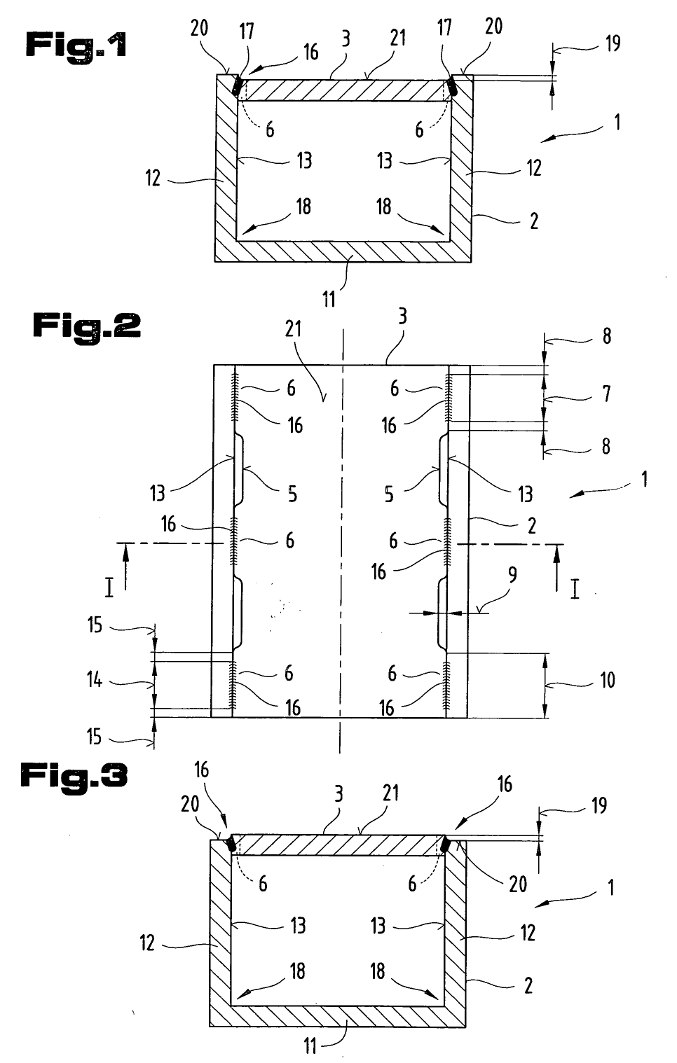

FIG. 1 shows an assembly according to the invention in cross section along the lines I-I in FIG. 2, in a much simplified view;

FIG. 2 shows the assembly according to FIG. 1 in plan view;

FIG. 3 shows a further embodiment of the component according to the invention, in cross section in front elevation and in a much simplified view;

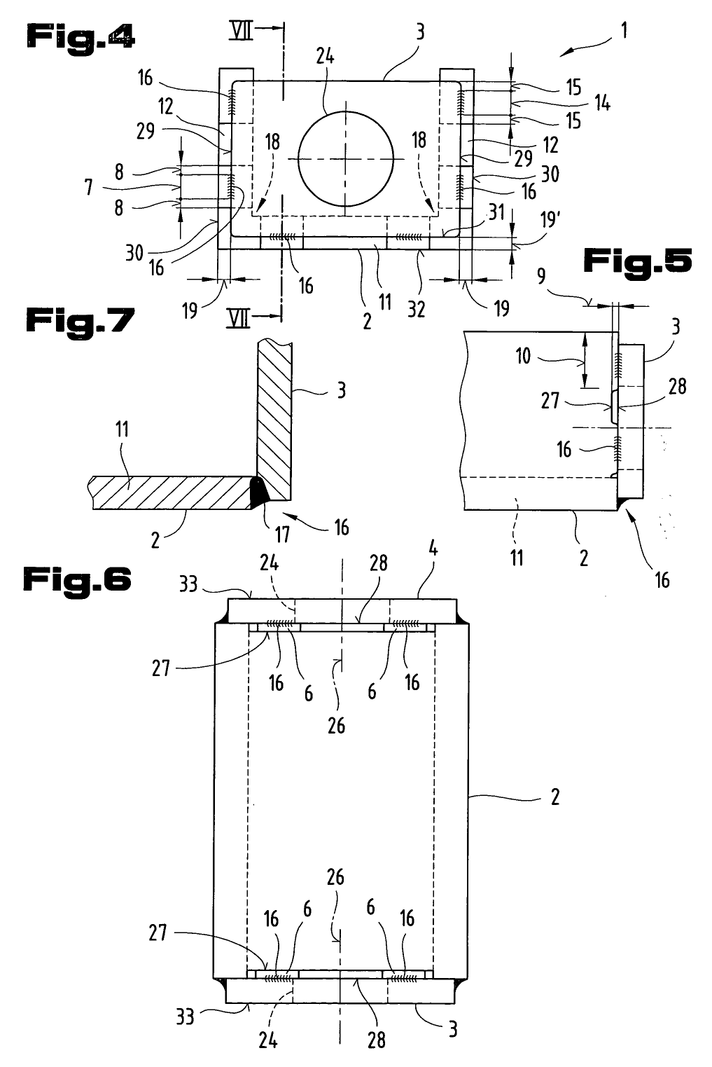

FIG. 4 shows a different design of the assembly according to the invention in front elevation and in a much simplified view;

FIG. 5 shows a partial section of the assembly according to FIG. 4 in side view;

FIG. 6 shows the assembly according to FIG. 4 in a view from below;

FIG. 7 shows a partial section of the assembly, in cross section along lines VII-VII in FIG. 4;

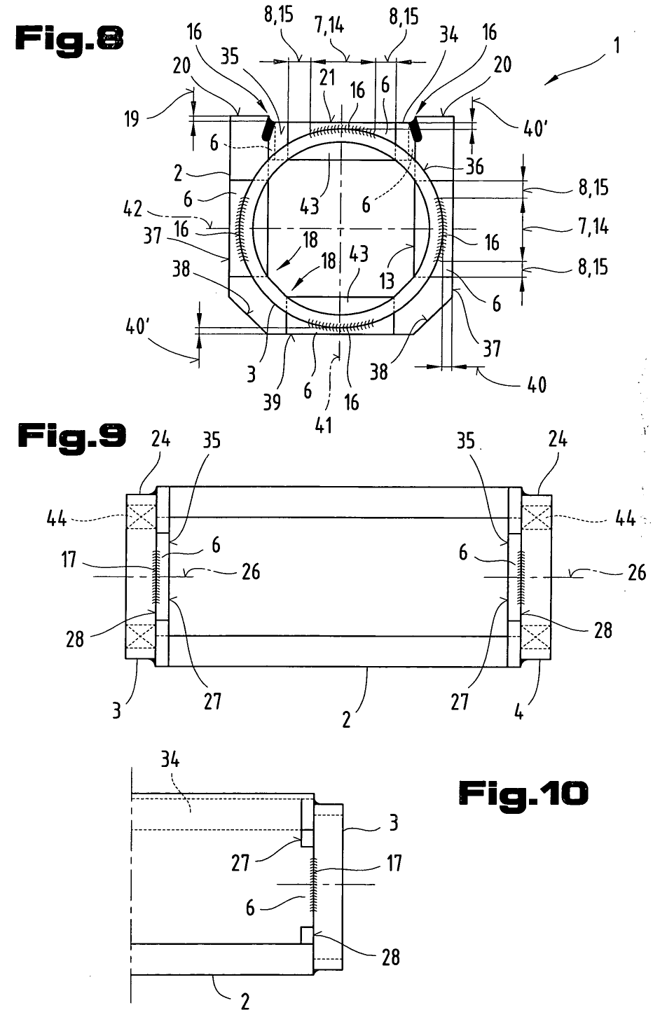

FIG. 8 shows a further embodiment variant of the assembly according to the invention in front elevation and in a much simplified view;

FIG. 9 shows the assembly according to FIG. 8 in a view from below;

FIG. 10 shows a partial section of the assembly according to FIG. 8 in a side view;

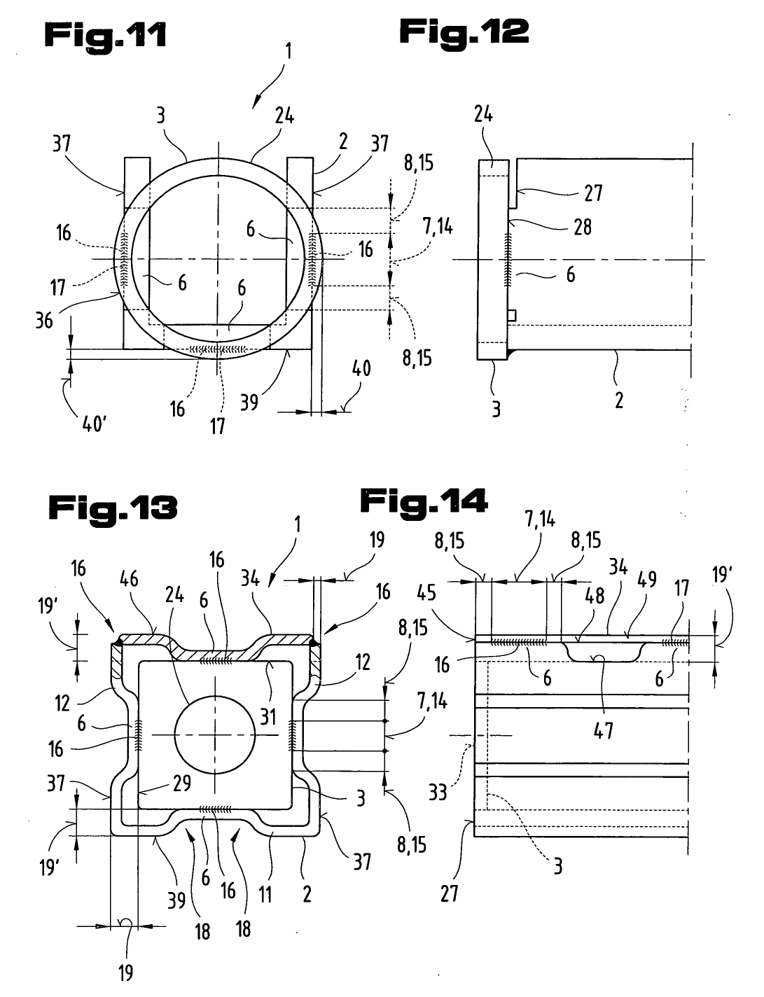

FIG. 11 shows a different embodiment variant of the assembly according to the invention in front elevation and in a much simplified view;

FIG. 12 shows a partial section of the assembly according to FIG. 11, in side view and in a much simplified view;

FIG. 13 shows a further embodiment variant of the assembly according to the invention, in partial cross section and in a much simplified view;

FIG. 14 shows a side view of the assembly according to FIG. 13;

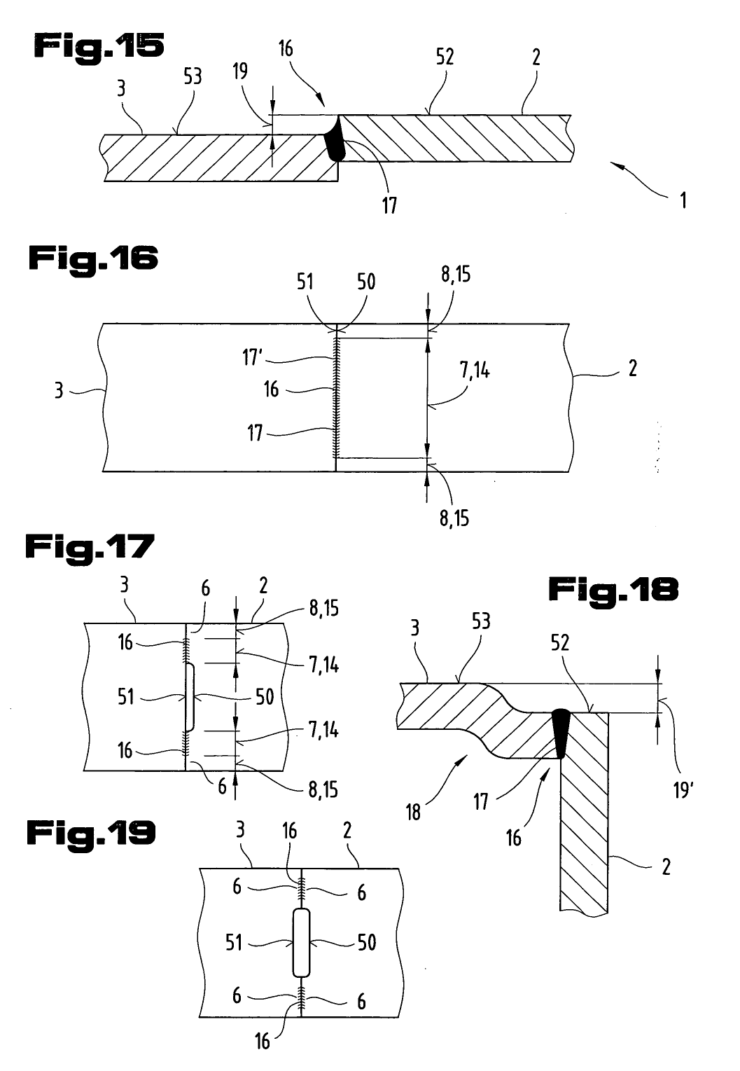

FIG. 15 shows a further embodiment variant of the assembly according to the invention in side view and in a much simplified view;

FIG. 16 shows the assembly according to FIG. 15 in plan view;

FIG. 17 shows a section of the assembly according to the invention with a first embodiment for a weld connection, in plan view;

FIG. 18 shows a section of the assembly according to the invention in a further embodiment variant, in cross-section and in a simplified view;

FIG. 19 shows a plan view of a section of the assembly according to the invention with a further embodiment of a weld connection;

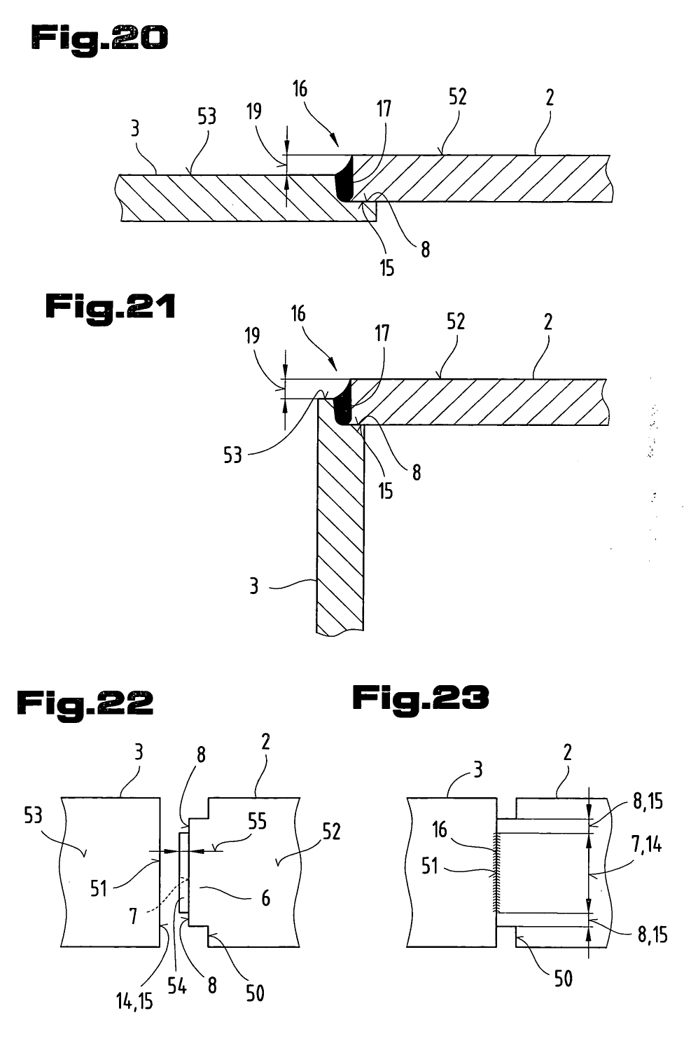

FIG. 20 shows a section of the assembly according to the invention in a different embodiment variant, in cross section in side view and in a simplified view;

FIG. 21 shows a section of the assembly according to the invention in a further embodiment variant, in side cross sectional view and in a simplified view;

FIG. 22 shows a first embodiment of a welding connection on the assembly to be produced before the welding of the two parts, in plan view and in a much simplified view;

FIG. 23 shows the welding connection according to FIG. 22 after the welding of the parts to form a component according to the invention, in plan view and in a simplified view;

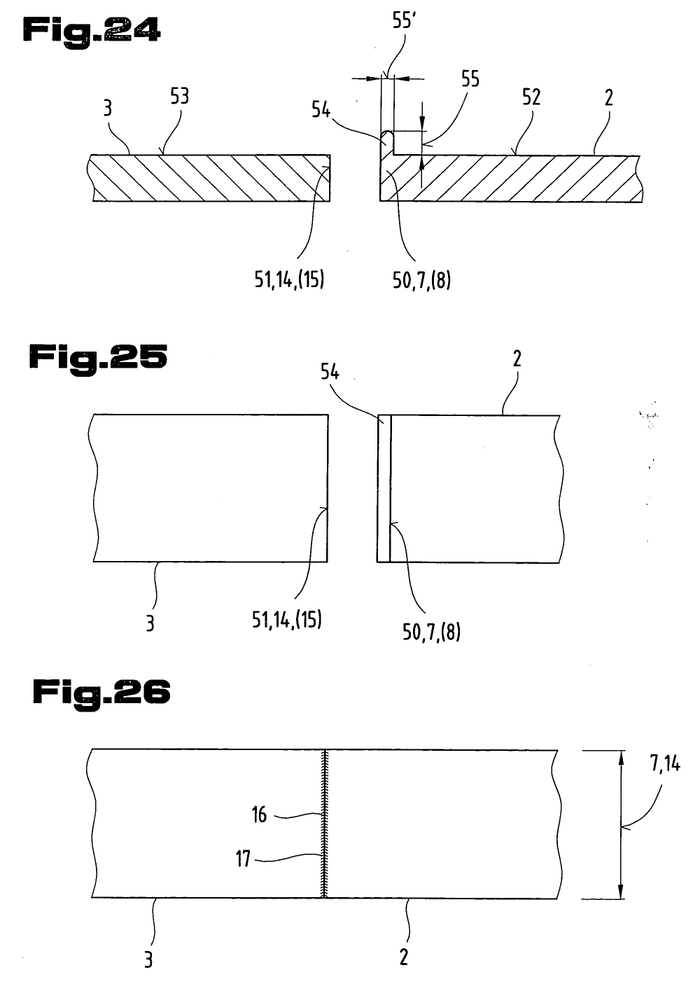

FIG. 24 shows a second embodiment of a welding connection on the assembly to be produced, before the welding of the two parts in cross section and in a much simplified view;

FIG. 25 shows the welding connection according to FIG. 24 in plan view and in a simplified view;

FIG. 26 shows the welding connection according to FIG. 24, after welding the parts to form a component according to the invention, in plan view and in a simplified view;

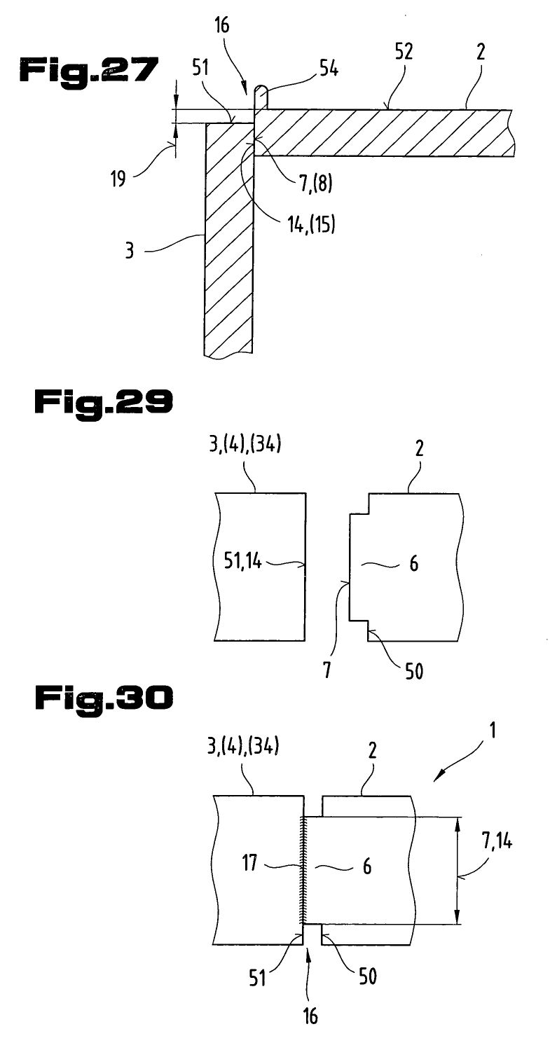

FIG. 27 shows a third embodiment of a welding connection on the component to be produced prior to the welding of the abutting parts, in cross section and in a much simplified view;

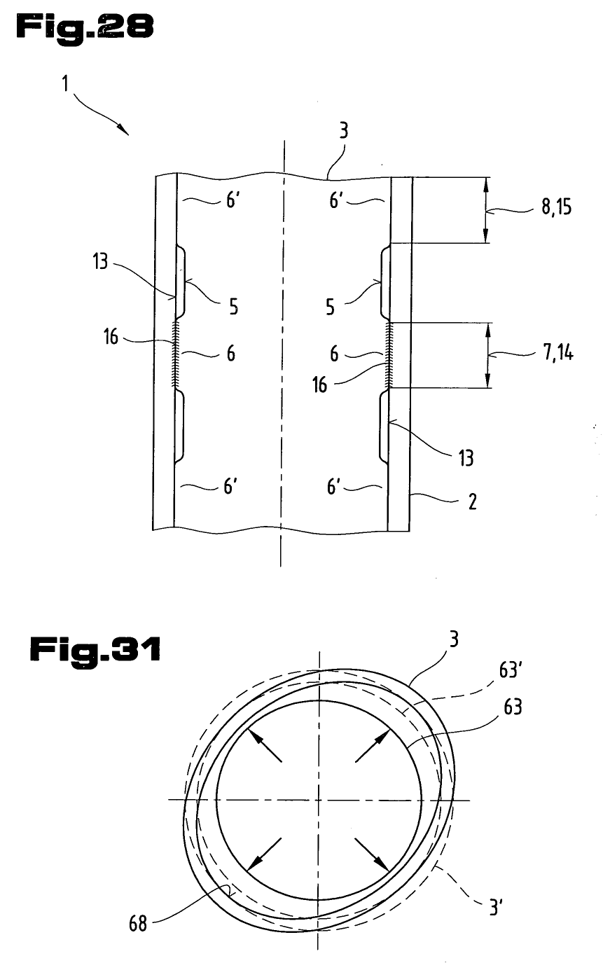

FIG. 28 shows a plan view of two parts welded together;

FIG. 29 shows a fourth embodiment of a welding connection on the assembly to be produced, before welding the parts, in plan view and in a much simplified view;

FIG. 30 shows the welding connection according to FIG. 29 after the welding of the parts to form a component according to the invention, in plan view and in a simplified view:

FIG. 31 shows a part in imperfect form (solid lines) and corrected form (dashed lines) and a clamping tool in an inactivated starting position, in front elevation and in a much simplified view;

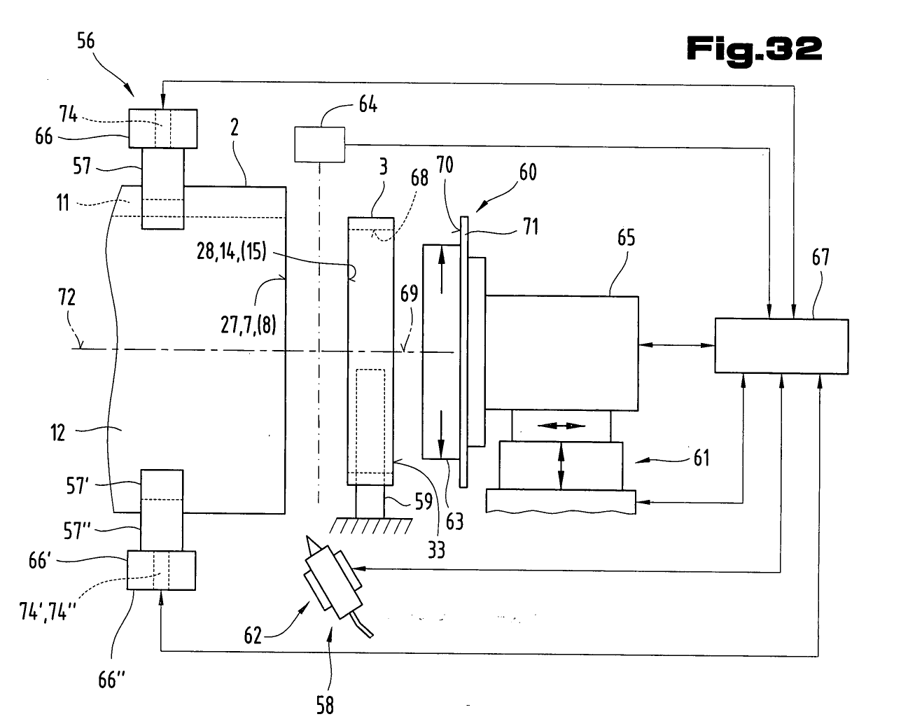

FIG. 32 shows a welding system according to the invention for producing the assembly according to the invention, in view and in a much simplified representation.

First of all it should be noted that in the variously described embodiments the same parts are denoted by the same reference numbers and the same component names, whereby the disclosures contained throughout the description can be applied accordingly to the same parts with the same reference numbers or same component names. The details used in the description relating to position such as top, bottom, side etc. refer to the Figure being described at the time, and where there is a change of position should be adjusted to the new position accordingly. Furthermore, individual features or combinations of features of the shown and described embodiments can in themselves represent independent, inventive solutions. It should also be noted at this point that the bending edges forming the deformation areas 18 are only represented schematically.

In the jointly described FIGS. 1 to 3 a first embodiment variant of the assembly 1 according to the invention is shown in different views. The assembly 1 consists according to this embodiment of two parts 2, 3, in particular sheet metal parts made of steel. The first part 2 is made from a piece of metal sheet that is cut to size, preferably stamped and then shaped into a U-shape in cross section, preferably bent. The second part 3 is also made from a preferably stamped, flat piece of metal sheet part cut to size. The two parts 2, 3 are thus produced purely by shaping and deformation without creating chippings.

As best shown in FIG. 2, the second part 3 is provided on its lateral surface parts 5 facing away from one another and running parallel in the direction of a longitudinal axis with several spaced apart mounting and positioning projections 6. Said mounting and positioning projections 6 project over the surface parts 5 and form at their free ends respectively a flat mounting surface 7 and at least one, preferably two positioning surfaces 8 arranged on both sides of the mounting surface 7. The mounting and positioning surfaces 7, 8 of each mounting and positioning projection 6 border one another directly and run in a plane parallel to the surface parts 5. Likewise, the mounting and positioning surfaces 7, 8 of all mounting and positioning projections 6 run on either side of the second part 3 within one plane. The mounting and positioning projections 6, which according to this embodiment lie opposite one another symmetrically in relation to the longitudinal axis, are produced in one piece with the piece of sheet metal cut to size, preferably purely by shaping without the creation of chippings.

Although the production of the parts 2, 3 without chippings according to the stamping method is the preferred embodiment, it would be possible for the latter to be produced from a piece of sheet metal cut out by a laser or water jet. Provided that the economical production of the assembly 1 is not a priority it is also possible to use parts 2, 3 produced by tensioning.

A height 9 of the mounting and positioning projection 6 is approximately between 0.1 mm and 2.0 mm or 5% and 50% of the thickness or sheet thickness of the second part 3. In practice 0.1 mm has proved to be advantageous, mainly with respect to saving material. The first and/or second part 3 is designed to have a thickness or sheet thickness of between 1.0 mm and 4 mm, in particular between 1.5 mm and 3 mm, for example 2 mm. A length 10 of the mounting and positioning projection 6 is preferably between 6 mm and 70 mm. However, in practice it has been shown that the length 10 should be at least double the thickness or sheet thickness of the second part 3. The width of the mounting and positioning projection 6 corresponds to the thickness or sheet thickness of the second part 3. The first part 2 has a base 11 and two legs 12 projecting perpendicular therefrom. The legs 12 of the first part 2 form on their facing, planar surface parts 13 respectively mounting surfaces 14 and at least one, preferably two positioning surfaces 15 arranged on both sides of the mounting surfaces 14. The surface part 13, the mounting and positioning surfaces 14, 15 run parallel to one another and in one plane.

As shown in these Figures, the second part 3 is arranged between the legs 12 of the first part 2 so that the mounting and positioning surfaces 7, 8, 14, 15 of the first and second part 2, 3 are aligned relative to one another and run in a parallel plane to one another. The planar mounting and positioning surfaces 7, 8, 14, 15 run parallel to one another and parallel to the respective surface parts 5, 13.

The corresponding mounting surfaces 7, 14 of the parts 2, 3, which abut against one another essentially without a gap, form a joint 16 respectively along which a welding beam (not shown) is guided, so that a weld 17 is formed which consists of the base material (substance) melted in sections of the parts 2, 3 to be welded together. According to the embodiment shown, three joints 16 are formed on each side in relation to the longitudinal axis. The welding is thus conducted in a contact-free manner by beam welding, in particular laser or electron beam welding, i.e. by low energy welding methods which permit so-called “deep welding” and are characterised in that very slim weld dimensions are obtained with a high depth-width ratio and only a low level of stretching energy is required, resulting in only a very small heat-affected zone. Moreover, the thermal load on the parts 2, 3 to be welded together can be kept very low, so that the distortion of the parts 2, 3 is minimal. For the mass production of the assembly 1 according to the invention laser welding is predominantly used, in particular with a solid-state laser, for example an Nd:YAG-laser, which mainly gives the welding system a high degree of flexibility.

In a preferred embodiment the two parts 2, 3 are joined together only by the welds 17 consisting of the base material (substance) melted in sections by means of the welding beam on the joint 16 or on the mounting surfaces 7, 14. In addition, once the parts 2, 3 have been positioned relative to one another and secured the welding beam is guided along the joint 16. The enormous energy density (about 10⁶ W/cm²) of the welding beam, in particular the laser beam, in focus causes the base material (substance) to melt. Whereas in the advancing direction of the welding beam base material is melted the melt from the two parts 2, 3 flows behind into one another. The melted and mixed material cools and the melt hardens to form a narrow weld 17. The depth of the weld with “deep welding” is at least 0.03 times to 0.5 times the thickness or sheet thickness. If a square-groove weld is made the weld depth corresponds essentially to the simple thickness or sheet thickness. The two parts 2, 3 are preferably joined together only by the base material without any additional material.

Naturally it would also be possible for the two parts 2, 3 to be joined together by the weld 17 at the relevant joint 16 produced by the addition of an additional material and the base material (substance) of the parts melted in sections.

As both of these technologies are known to a person skilled in the art a more detailed description is not entered into in the present application.

As shown in the Figures, each weld 17 is formed at the relevant joint 16 as a fillet weld and along the respective joint 16, whereby the weld 17 extends exclusively over the entire length of the respective joint 16. The length of the weld 17 in the form of a line weld or of the joint 16 is between 4 mm and 30 mm, whereas the length of the allocated, interacting positioning surfaces 8, 15 is between 1 mm and 20 mm respectively. In this way it is ensured that during the entire welding process the two parts 2, 3 pressed against one another at the mounting surfaces 7, 14 with a preloading force remain aligned relative to one another exactly over their adjusted positioning surfaces 8, 15 and are not offset relative to one another at the joint 16 due to the melt bath produced during welding. It is also an advantage if as few as possible welds are formed on the assembly and longer welds 17 are formed, whereby the production of the assembly 1 is made easier.

The two parts 2, 3 are positioned relative to one another so that the second part 3 with the first part 2 forms joints 16 only in those sections of the first part 2 in which the dislocation density of the base material is lower than the dislocation density in the deformation areas 18 produced on the first part 2 by cold forming, therefore welding takes place in the region outside the bending edges between the base 11 and the legs 12. In this way a change in structure in the deformation areas 18 is avoided and the advantageous increase in strength obtained by cold forming is maintained in the deformation areas 18. The increase in strength results from a greater degree of shaping in the deformation areas 18, which can be optimised according to the strength requirements for the assembly 1 once welding has occurred outside the deformation areas 18 or shaping areas. It is now entirely possible to select the degree of deformation to be between about 15% and 40%, in particular about 25%. A heat treatment after welding can be omitted. The hardness of the deformation area 18 adjoining the base material is about 25% to 50% higher than the base material. The tensile strength correlates approximately to the same extent to the hardness. The hardness test is for example a Vickers hardness test (DIN 50 133).

Assemblies 1 often have to meet functional requirements for outer surface parts 30, 32 (as shown in FIG. 4). For example they slide onto other assemblies 1 or there are optical requirements for the outer surface parts 30, 32, which would be affected by the welds 17. The welds 17 must not project over these surface parts 30, 32. As with beam welding a welding seam 17 is created, albeit very narrow, a solution needs to be found to ensure that the latter is set back from the surface parts 30, 32 and is not noticeable. This is achieved by means of the offset 19, 19′, 40, 40′ of parts 1 to 4, 34 described in the following.

For this it is provided that the surface parts 20, 21 of the parts 2, 3 running at an angle to the mounting surfaces 7, 14 essentially parallel to one another are arranged offset relative to one another by an offset 19 in the direction of a plane parallel to the mounting surfaces 7, 14, so that the parts 2, 3 abutting against one another by means of the mounting surfaces 7, 14 form a step at least at the relevant joints 16. The angle measured in a plane running perpendicular to the longitudinal direction of the parts 2, 3 between the mounting surface 7, 14 and the surface part 20, 21 is about 90°. This offset 19 is between 5% and 50% of the maximum thickness or sheet thickness of a part 2, 3, i.e. between 0.1 mm and 2.0 mm. In practice 0.1 mm to 0.3 mm have proved advantageous mainly in respect of the smooth and even transition of the weld 17 from one part to the other 2, 3, so that a surface of the weld 17 spans over the step in the region of the respective joint 16 at right angles to the longitudinal direction of the step and the adjoins the weld 17 at the surface parts 20, 21 or an optimal weld rounding is formed, as viewed in a direction perpendicular to the longitudinal direction of the joint 16. In this way an optimum force flow is achieved via the weld 17 and a high-strength connection between the parts 2, 3. The end face surface parts of the second part 3 are aligned flush with the end face surface parts of the first part 3.

The offset 19 corresponds to an edge offset between an edge of the first part 2 formed by the adjoining surface parts 13, 20 and an edge of the second part 3 formed by the adjoining surface parts 5, 21. According to FIG. 1 the second part 3 in a direction perpendicular to the surface part 21 is offset inwardly to the side of the first part 3 and according to FIG. 3 offset outwardly to the opposite side of the first part 3. The offset 19 is required at least at those sections of the assembly 1 where the abutting parts 2, 3 form the joints 16. It is essential that the joints 16 are always formed remote from the outer contour of one of the two parts 2, 3 and are set back relative thereto.

In the jointly described FIGS. 4 to 7 a second embodiment variant of the assembly 1 according to the invention is shown in different views. The assembly 1 consists in this embodiment of three parts 2, 3, 4, in particular sheet metal parts made of steel. The first part 2 is made from a sheet metal piece that is cut to size, preferably stamped and then shaped in cross section into a U-shape, preferably bent. The second and third part 3, 4 are designed to be identical and are produced respectively from a preferably stamped sheet metal piece that is cut to size, whereby a bearing eye 24 is formed on the latter. From the even sheet metal piece for the second and third part 3, 4 respectively a round through opening forming the bearing eye 24 is stamped out. After the stamping out the round through opening can be calibrated as necessary. As not shown in detail, the bearing eye 24 can also be formed by a sleeve formed on the flat sheet metal piece for the second and third part 3, 4, for example by deep drawing or shearing. The bearing eye 24 of the second and third part 3, 4 can also form an outer or inner ring of a bearing. The second and third part 3, 4 then form respectively a planar supporting plate and the sleeve. The three parts 2 to 4 are thus produced purely by shaping and deformation without creating chippings.

As shown in FIG. 6 the second and third part 3, 4 are provided on the face ends of the first part 2 and are connected to the latter by means of welding connections described in more detail below. The bearing eyes 24 of the second and third part 3, 4 are arranged coaxially relative to one another and the axes 26 thereof form a common axis. The axes 26 are arranged perpendicular to the surface parts 27, 28. If the bearing eyes 24 are formed respectively by the deep drawn or sheared sleeve described above their front side ends projecting over the flat support plate are directed away from one another.

The first part 2 in the direction of its longitudinal extension in cross section has a U-shape, the base 11 and the legs 12 projecting perpendicularly therefrom. The profile-like, second part 2 forms surface parts 27 facing away from one another at the front face ends, which lie in a plane running perpendicularly to the longitudinal direction of the part 2 and on which respectively several mounting and positioning projections 6 are provided. As shown in the embodiment, two mounting and positioning projections 6 are arranged respectively on the front end surface parts 27 on the base 11 and two mounting and positioning projections 6 are arranged respectively on the front side surface parts 27 of each leg 12 of the first part 2. The mounting and positioning projections 6 on the base 11 and also the legs 12 are arranged spaced apart from one another separately and project over the surface parts 27 and form at their free ends an even mounting surface 7 and at least one, preferably two, positioning surfaces 8 adjoining both sides of the mounting surface 7.

The mounting and positioning surfaces 7, 8 of each mounting and positioning projection 6 run in a plane parallel to the surface parts 27. Likewise the mounting and positioning surfaces 7, 8 of all mounting and positioning projections 6 run in one plane at both front ends of the first part 2. The mounting and positioning projections 6 are produced in one piece with the sheet metal piece for the first part 2, preferably purely by shaping without producing any chippings. The second and third part 3, 4 are provided respectively on their surface parts 28 facing surface parts 27 with mounting and positioning surfaces 14, 15. According to this embodiment the surface part 28 and the mounting and positioning surfaces 14, 15 are arranged in one plane and run parallel to the mounting and positioning surfaces 7, 8 of the first part 2.

The mounting surfaces 7, 14 of parts 2 to 4 abutting against one another, essentially without a gap, form a joint 16 respectively, along which a not shown welding beam, in particular laser beam, is guided, so that a weld 17 is produced which is in the form of a square-groove weld (FIG. 7) and extends essentially over the entire length of the respective joint 16.

The parts 2, 3, 4 are positioned relative to one another, as already described above, so that the joints 16 are formed in those sections of the first part 2, in which the dislocation density of the base material is lower than the dislocation density in the deformation areas 18 produced on the first part 2 by cold forming or the only schematically shown bending edges between the base 11 and legs 12.

As indicated in FIG. 4 the surface parts 29, 30, 31, 32 of parts 3, 4 running at an angle to the mounting surfaces 7, 14 and essentially parallel to one another are arranged offset relative to one another by an offset 19, 19′ in the direction of a plane parallel to the mounting surfaces 7, 14, so that the parts 2, 3, 4 abutting against one another via the mounting surfaces 7, 14 form a step at the joints 16 concerned. The angle between the mounting surface 7 and the surface part 30, 32 of the first part 2 is preferably about 90°. Likewise the angle between the mounting surface 14 and the surface part 29, 31 of the second and third part 3, 4 is preferably about 90°. This offset 19, 19′ is, as already described to advantage, between 5% and 50% of the maximum thickness or sheet thickness of a part 2, 3, i.e. between 0.1 mm and 2.0 mm. It is essential that the joints 16 delimited by the mounting surfaces 7, 14 are designed to be continually set apart from an external contour of one of the parts 2, 3 or 4 and are set back according to the embodiment shown relative to the outer contour of the profile-like first part 2.

The horizontal offset 19 corresponds to an edge offset between an edge of the second or third part 3, 4 delimited by adjoining surface parts 29, 33 and an edge of the first part 2 delimited by adjoining surface parts 27, 30, and the vertical offset 19′ corresponds to an edge offset between an edge of the second and third part 3, 4 delimited by adjoining surface parts 31, 33 and an edge delimited by adjoining surface parts 27, 32. The front side surface part 33 of the second or third part 3, 4 facing away from the front end of the first part 2 runs parallel to the surface parts 27 of the first part 2.

In the jointly described FIGS. 8 to 10 the assembly 1 according to the invention is shown in a different embodiment variant and in different views. The assembly 1 consists according to this embodiment of three parts 2, 3, 4, in particular sheet metal parts and if necessary a fourth part 34, in particular a sheet metal part made of steel. The first part 2 is produced from a sheet metal piece that is cut to size, preferably stamped and then shaped into a trapezoid shape in cross section, preferably bent. The second and third part 3, 4 are formed respectively by a sleeve with a circular-annular cross section in a plane perpendicular to its longitudinal extension. Each of the sleeves forms a bearing eye 24 and is joint-free. To increase the transverse rigidity of the assembly 1 a fourth part 34 is provided which is produced from a flat sheet metal piece cut to size and preferably stamped.

The sleeve-shaped parts 3, 4 are provided on the front ends of the first part 2, whereas the fourth part 34 is arranged between the legs 12 projecting up from the base 11 of the first part 2. The profile-like first part 2 and the sleeve-shaped parts 3, 4 are provided on their facing surface parts 27, 28 with mounting and positioning surfaces 7, 14, 8, 15 aligned relative to one another. The mounting and positioning surfaces 7, 8 of the first part 2 are formed by mounting and positioning projections 6 projecting past it's averted, front side surface parts 27 and formed on the latter. As indicated in FIG. 8 on the face side surface parts 27 of the first part 2 on the base 11 and the legs 12 respectively only one mounting and positioning projection 6 is arranged, whereby the surface parts 27 are arranged respectively in a plane running perpendicular to the longitudinal direction of the first part 2. The mounting and positioning surfaces 7, 8 of each mounting and positioning projection run in a plane parallel to the surface parts 27. The mounting and positioning projections 6 are produced in one piece with the sheet metal piece for the first part 2, preferably purely by shaping without the production of chippings.

The mounting and positioning surfaces 14, 15 of the sleeve-shaped part 3, 4 facing the front end or surface parts 27 of the first part 2 run parallel in a plane with the surface part 28 and parallel to the mounting and positioning surfaces 7, 8 of the first part 2.

The strip-like, planar, fourth part 34 is provided on its lateral surface parts 5 (not indicated) respectively, which run in parallel in the direction of the longitudinal axis and face away from one another, with several mounting and positioning projections 6 arranged spaced apart from one another, as already described in detail in FIGS. 1 to 3, which with their mounting surfaces 7 and the mounting surfaces 14 on the first part 2 delimit the joints 16, at which the first part 2 is welded to the fourth part 34. In addition, the fourth part is equipped on its front side surface parts 35 facing away from one another with mounting and positioning surfaces 7, 8. Said front side mounting and positioning surfaces 7, 8 are formed respectively by a mounting and positioning projection 6 projecting past the surface parts 35. The mounting and positioning projections 6 facing away from one another are produced in one piece with the sheet metal piece for the fourth part 34, preferably by shaping without producing any chippings.

Opposite the front side mounting and positioning surfaces 7, 8 of the fourth part 34 mounting and positioning surfaces 14, 15 are formed on the second and third part 3, 4, which run in one plane with the surface part 28. The front side surface part 28 of the second or third part 3, 4 runs parallel to the surface parts 27 of the first part 2.

The mounting surfaces 7, 14 of the parts 2, 3, 4, (34) allocated to one another and abutting against one another without a gap form a joint 16 respectively, along which a weld 17 is placed essentially over its entire length. Said welds 17 are in the shown embodiment all formed by a fillet weld. Because of the fact that the welds 17 are formed respectively only over the length of the joint 16, the two parts 2, 3, 4, (34) to be welded together are aligned relative to one another exactly by the relatively aligned positioning surfaces 8,15, also whilst the parts 2, 3, 4, (34) are being welded together.

The parts 2, 3, 4, (34) are positioned relative to one another, so that the second, third and possibly fourth part 3, 4, (34) with the first part 2 forms joints 16 only in those sections in which the dislocation density in the joint is lower than the dislocation density in the deformation areas 18 formed on the first part 2 by cold forming. As the welds 17 are now arranged outside the deformation areas 18 or bending edges a change of the good strength properties created by cold forming are avoided, as described above.

The sleeve-shaped part 3, 4 forms on its outer peripheral surface the surface part 36, which together with the mounting surface 14 encloses a right angle. Likewise the approximately trapezoidal, first part 2 forms towards the outer peripheral surface of part 3, 4 adjacent surface parts 20, 37, 38, 39, which enclose a right angle respectively with the relevant mounting surface 7. As shown in FIG. 8, the surface parts 21, 36, 37, 39 of parts 2, 3, 4, 34 pointing to the same side are arranged offset relative to one another by an offset 40, 40′ in the direction of a plane parallel to the mounting surfaces 7, 14, so that the parts 2, 3, 4, 34 to be welded together form a step at least on the joint 16 formed by the mounting surfaces 7, 14 of the parts 2, 3, 4, 34 abutting against one another without a gap. Likewise the surface parts 20, 21 of parts 2, 34 are arranged offset relative to one another about the offset 19 in the direction of a plane parallel to the mounting surfaces 7, 14, as already described in detail above. It is essential, that the joints 16 are always removed from an external contour of one of the parts 2, 3, 4, 34 to be welded and are set back relative to the latter.

The horizontal offset 40 corresponds to a normal distance between an edge of the first part 2 delimited by adjoining surface parts 27, 37 part 2 and a tangent placed on the outer peripheral surface of the sleeve and running parallel to the vertical gravity axis 41 of the profile-like part 2. The vertical offset 40′ corresponds to a normal distance between an edge of the first and fourth part 2, 34 delimited by adjoining surface parts 27, 39, 21, 35 and a tangent placed on the outer peripheral surface of the sleeve and running parallel to the horizontal gravity axis 42 of the profile-like part 2.

As shown in FIG. 8 the internal diameter of the sleeve is smaller than the width of the U-shaped part 2 and slightly larger than the internal width between the legs 12 of the first part 2. Each sleeve defines circular sections on the mounting and/or positioning surfaces 7, 8 provided on the first part 2 at the front end, which circular sections form the support surfaces 43, against which a bearing 44, in particular a roller or sliding bearing, shown only in dashed lines in FIG. 9 is positioned. By means of the bearing 44 a not shown shaft, in particular a steering shaft of a motor vehicle is mounted rotatably on the assembly 1. The assembly 1 according to the invention is designed in this embodiment as a bearing box or steering housing for surrounding the steering shaft, and is characterised in particular by its high rigidity, the simple and precise bearing of the shaft and the economic production thereof.

The embodiment variant of the assembly 1 according to the invention described in FIGS. 11 and 12 differs from the one according to FIGS. 8 to 10 only in that the first part 2, in particular the sheet metal part is designed to be U-shaped in cross section and the sleeve-shaped part 3, 4 has an external diameter which is greater than the width of the U-shaped part 2, whereas the internal diameter of the sleeve-shaped sheet metal section 3, 4 is slightly greater than the internal width between the legs 12 of the first part 2, so that each sleeve defines circular sections on the mounting and/or positioning surfaces 7, 8 provided on the first part 2. The welds 17, which are arranged on the relevant joints 16 delimited by the allocated, interacting mounting surfaces 7, 14 of the parts 2, 3, 4 to be welded together, are designed as fillet welds between the perpendicularly aligned surface parts 28, 37, 39 of the first, second and third part 2, 3, 4. The sleeve-shaped part 3, 4 forms on its outer peripheral surface the surface part 36, which together with the mounting surface 14 encloses a right angle. Likewise, the approximately U-shaped part 2 towards the outer peripheral surface of part 3, 4 forms adjacent surface parts 37, 39, which enclose respectively a right angle with the relevant mounting surface 7. As indicated in FIG. 11, the surface parts 36, 37, 39 of parts 2, 3, 4 pointing to the same side are arranged offset by the offset 40, 40′ in the direction of a plane parallel to the mounting surfaces 7, 14, so that the parts 2, 3, 4 to be welded together, at least at the joints 16 formed by the mounting surfaces 7, 14 of the parts 2, 3, 4 abutting against one another without a gap, form a step respectively. The sleeves after positioning relative to the first part 2 are then welded together at the joints 16 on the rear side facing the front end of the first part 2.

In the jointly described FIGS. 13 and 14 a further embodiment variant of the assembly 1 according to the invention is shown in different views. The assembly 1 consists in this embodiment of four parts 2, 3, 4 (not included in this Figure) 34, in particular sheet metal parts made of steel. The first and fourth part 2, 34 or metal sheet are produced purely by shaping and deformation, without producing chippings. For this on a sheet metal piece that is cut to size and preferably stamped, parallel longitudinal grooves are made firstly along its longitudinal extension. After this the sheet metal piece is shaped into the U-shape to form the first part 2. The second and third part 3, 4 are designed to be identical and are produced respectively from a sheet metal piece that is cut to size and preferably stamped, from which the bearing eyes 24 are stamped out. Thus parts 3, 4 are also produced purely by shaping without producing chippings. The fourth part 34 is also produced from a flat sheet metal piece that is cut to size and preferably stamped, on which a longitudinal groove extending in its longitudinal direction is formed which is shaped from the even sheet metal piece.

The U-shaped first part 2 or sheet metal part is provided on its legs 12 and the base 11 connecting the latter respectively with a mounting and positioning projection 6, which is formed by the longitudinal groove. Said mounting and positioning projections 6 project over the surface parts 37, 39 formed on the outside of the first part 2, and form at their free ends respectively a flat mounting surface 7 and at least one, preferably two positioning surfaces 8. The mounting and positioning surfaces 6, 7 of each mounting and positioning projection 6 run in one plane and parallel to the surface parts 37, 39.

The second and third part 3 or sheet metal part are, as viewed from the front side, designed to be approximately rectangular or quadratic and are provided on the front ends of the first part 2, and connected therewith via welding connections that will be described in more detail below. Each of said parts 3, 4 forms on its outer peripheral surface two parallel running surface parts 29 and two surface parts 31 running at right angles to the latter. Said surface parts 29, 31 form the mounting and positioning surfaces 14, 15 and run with the latter in a plane and parallel to the mounting and positioning surfaces 7, 8. In a possible variant the surface part 33 of the parts 3, 4 facing away from the first part 2 lies flush with the front side surface part 27 of the first part 2.

The fourth part 34 or sheet metal part also comprises a mounting and positioning projection 6, which is formed by the longitudinal groove and comprises a mounting surface 7 and at least one, preferably two positioning surfaces 8 provided on both sides of the latter. Front side surface parts 45 of the fourth part 34 lie flush with the surface parts 27 of the first part 2. The described mounting and positioning projections 6 of parts 2, 34 are aligned relative to one another.

The mounting surfaces 7, 14 of parts 2, 3, 4, 34 abutting against one another essentially without a gap form a joint 16 respectively, along which a not shown welding beam is guided, so that a weld 17 is formed which is in the form of a square-groove weld and extends essentially over the entire length of the respective joint 16 which is delimited by the abutting mounting surfaces 7, 14.

The fourth part 34 is welded on the one hand to the second and third parts 3, 4 and on the other hand to the legs 12 of the first part 2. For this on the legs 12 on the freely projecting surface parts 47 respectively several mounting and positioning projections 6 are provided arranged spaced apart from one another in the direction of the longitudinal axis of the first part 2.

Each mounting and positioning projection 6 comprises the mounting surface 7 and the positioning surfaces 8 formed on both sides of the latter. The fourth part 34 is provided on the surface part 48 facing the legs 12 with mounting and positioning surfaces 14, 15 allocated to the mounting and positioning projections 6. The mounting surfaces 7, 14 of the parts 2, 34 abutting against one another without a gap form a joint 16 respectively, along which the weld 17 is formed. The weld 17 at the joints 16 is in the form of a fillet weld or a square-groove weld. The surface parts 49 facing away from one another and running in the direction of the longitudinal axis and the surface parts 37 of the first part 2 facing away from one another are arranged offset relative to one another by an offset 19 in the direction of a plane parallel to the mounting surfaces 7, 14, so that the parts 2, 34 abutting against one another by means of the mounting surfaces 7, 14 form a step in the relevant joints 16.

As included in the Figures the surface parts 37, 39, 29, 31, 46 of the parts 2, 3, 4, 34 running parallel to the mounting surfaces 7, 14 are arranged offset relative to one another about a horizontal and vertical offset 19, 19′ in the direction of a plane parallel to the mounting surfaces 7, 14, so that the parts 2, 3, 4, 34 abutting against one another form a step at the relevant joints 16.

The joints 16 are arranged in this case outside the deformation areas 18 produced by cold forming, therefore the bend edges, so that the welds 17 are arranged in those sections of the shaped part 2 in which the dislocation density of the base material is lower than the dislocation density in the deformation areas 18. The start and end sections of the welds 17 lie spaced apart from the respective deformation area 18 respectively by at least double the thickness or sheet thickness. The positioning surfaces 8,15 can adjoin the deformation areas 18 unlike the mounting surfaces 7, 14 or even be formed by the latter in parts.

In the jointly described FIGS. 15 and 16 a further embodiment variant of the assembly 1 according to the invention is shown in different views. The two parts 2, 3, in particular sheet metal parts, are made respectively from a sheet metal piece that is cut to size and preferably stamped, and on their facing surface parts 50, 51 the mounting and positioning surfaces 7, 14, 8, 15 running in a plane are formed. The parts 2, 3 lying against one another in a butt joint form the joint 16 delimited by the mounting surfaces 7, 14 of the parts 2, 3 which abut against one another essentially without a gap, along which joint 16 for example two welds 17, 17′ can be produced for example in opposite welding directions. However, only one weld 17 can be provided which extends continuously over the entire length of the joint 16. The two welds 17, 17′ are aligned towards one another and in the direction of a common meeting point, whereby adjacent end sections of the welds 17, 17′ overlap at a common meeting point or end at the common meeting point. The meeting point lies in a low tension area of the assembly or in an area that is not critical for its strength properties.

As illustrated in FIG. 15, the first part 2 forms a flat surface part 52, which with the mounting and positioning surfaces 7, 8 encloses a right angle, and the second part 3 forms a surface part 53, which with the mounting and positioning surfaces 14, 15 encloses a right angle. The surface parts 52, 53 of the parts 2, 3 are arranged offset relative to one another by an offset 19 in the direction of a plane parallel to the mounting surfaces 7, 14, so that the parts 2, 3 abutting against one another by means of the mounting surfaces 7, 14 form a step at the joint 16.

FIG. 17 shows a development of the mounting and positioning surfaces 7, 14, 8, 15 of two parts 2, 3 to be welded together, in particular sheet metal parts. One of the parts 2 is provided with two mounting and positioning projections 6, whereas the other part 3 has mounting and positioning surfaces 8, 15 which run in a plane with the flat surface part 51 pointing to part 2. The separated mounting and positioning projections 6 project over the surface part 50 and form respectively only one mounting surface 7 and a positioning surface 8 adjoining the latter. If the parts 2, 3 are placed against one another their mounting and positioning surfaces 7, 14, 8, 15 are opposite one another and the mounting surfaces 7, 14 form the joints 16, which are adjacent to one another. The two parts 2, 3 are arranged, as shown, in one plane or in two parallel planes but can equally be arranged in two planes which enclose a right angle.

FIG. 18 shows two welded parts 2, 3, in particular sheet metal parts, which are arranged in two planes at right angles to one another and their surface parts 52, 53 are arranged offset relative to one another by offset 19′ in the direction of a plane parallel to the mounting surfaces 7, 14 (not included). The second part 3 is provided at the front end with an impression and forms at its face end surface part the mounting and positioning surfaces 7, 14 (not included), whereby the surface part 52, 53 and the mounting and positioning surfaces 7, 14 enclose a right angle. Likewise the first part 2 on its surface part facing the second part 3 forms the mounting and positioning surfaces 8, 15 (not included). The mounting and positioning surfaces 7, 8, 14, 15 of the parts 2, 3 lie respectively in a plane with the flat surface part. If the parts 2, 3 are placed against one another their mounting and positioning surfaces 7, 14, 8, 15 are placed opposite one another and the mounting surfaces 7, 14 form at least one, preferably two separate joints 16. Each weld 17 extends over the length of the joint 16 outside the deformation area 18 and is in the form of a square-groove weld. This design has the advantage that the weld 17 does not protrude over the surface part 53 and therefore the surface part 53 can be used freely as a functional surface.

In FIG. 19 a variant of the welding connection between two parts 2,3, in particular sheet metal parts, is shown in which the facing surface parts 50, 51 are provided respectively with one, or as shown in this Figure, two mounting and positioning projections 6 running towards one another. The mounting and positioning projections 6 project over the surface parts 50 51 of the first and second part 2, 3. Each of the said mounting and positioning projections 6 comprises the not included mounting and positioning surfaces 7, 14, 8, 15. The mounting surfaces 7, 14 of the mounting and positioning projections 6 lying opposite one another in pairs abutting against one another without a gap form two joints 16, along which a weld 17 is placed respectively. The parts 2, 3 abutting against one another with the mounting surfaces 7, 14 in turn form the step, already described many times in embodiments above, at each joint 16 or run in one plane.

In the jointly described FIGS. 20 and 21 a partial section of the assembly 1 according to the invention is shown. According to FIG. 20 the parts 2, 3 to be welded, in particular the sheet metal parts, are arranged in two parallel planes, whereas according to FIG. 21 the two parts 2, 3 to be welded together, in particular sheet metal parts, are arranged in two planes and enclose an angle of preferably 90°. According to these embodiments the mounting surface 7, 14 (not shown in these Figures) and positioning surface 8, 15 of the first and second part 2, 3 enclose an angle of 90°. The mounting surfaces 7, 14 adjoining one another without a gap delimit the joint 16 along which the weld 17 is formed. The parts 2, 3 form the surface parts 52, 53, which with the mounting surfaces 7, 14 enclose an angle of 90° and run parallel to the positioning surfaces 8, 15. The surface parts 52, 53 are in turn arranged offset by the offset 19 in a plane parallel to the mounting surfaces 7, 14, so that the parts 2, 3 form a step at the joint 16.

In FIGS. 22 to 27 further embodiments of the welding connection for an assembly 1 are shown which if necessary form an independent invention. The first part 2, in particular a sheet metal part is provided according to FIGS. 22 and 23 on its surface part 50 facing the second part 2, in particular a sheet metal part, with at least one projecting mounting and positioning projection 6, which forms the mounting and positioning surface 7, 8 lying in a plane. The parts 2, 3 are either arranged offset relative to one another in one plane or in a direction perpendicular to the surface parts 52, 53, so that between the parts at least at the joint 16 a step is formed, as described above.

At least one of the parts 2 to be welded is provided on the upper side in the region of the edge adjacent to the opposite part 3 with a welding bar 54 that can be melted by a welding beam, in particular laser or electron beam, as illustrated in FIGS. 22, 24, 25 in a state prior to welding. This ridge-like welding bar 54 extends according to this embodiment above the mounting surface 7 over a length which corresponds to the entire length of the joint 16, along which the weld 17 is formed, as shown in FIG. 23. The edge is formed by the surface part 52 adjacent to the incidence side of the welding beam and the mounting surface 7 running at an angle thereto, wherein the angle enclosed between the latter is preferably 90°. The welding bar 54 has a height 55 corresponding to about between 5% and 50% of the maximum thickness or metal sheet thickness of the first part 2 and a width 55′ and projects over the mounting and/or positioning surface 7, 8. A height 55 and width 55′ of between 0.2 mm and 1.5 mm has been shown to be advantageous. The minimum length corresponds at least to double the sheet thickness of the first part 2.

FIGS. 24 to 26 show an embodiment in which the mounting surfaces 7, 14 are formed by the facing front side surface parts 50, 51 of the opposite parts 2, 3, in particular sheet metal parts. The mounting surfaces 7, 14 abutting against one another essentially without a gap form the joint 16, as shown in FIG. 26. The fin-like welding bar 54 extends in this embodiment over the mounting surface 7 over a length, which corresponds to the entire length of the edge or joint 16 along which the weld 17 is formed. It is essential that the welding bar 54 is arranged so that the mounting surfaces 7, 14 of the parts 2, 3 can definitely abut against one another bluntly or essentially without a gap. If necessary, the parts 2, 3 to be welded together have on their facing sides the mounting surface 7, 14 and additionally at least one, preferably two, parallel positioning surfaces 8, 15 arranged on both sides, which run in a plane with the relevant, front side surface part 50, 51. After the complete melting of the welding bar 54, a surface of the weld 17 runs approximately in the plane of the surface parts 52, 53.

The welding bar 54 is formed in one piece on the first part 2. If the first part 2 is designed for example as a stamped part the welding bar 54 can be formed by a stamped fin produced during the manufacturing process.

An embodiment shown in FIG. 27 is also advantageous in which the parts 2, 3 to be welded are arranged in two planes and enclose an angle of preferably 90°, wherein the outer, parallel surface parts 51, 52 are arranged offset relative to one another by the offset 19, so that between the parts 2, 3 at least on the joint 16 a step is formed, as described above. The surface parts 51, 52 respectively form a right angle with the even mounting surface 7, 14. After the melting of the welding bar 54 an optimum rounding of the weld (not shown) is achieved between the surface parts 51, 52.

By means of a suitable selection of a focus diameter and/or an inclination of the axis of the welding beam to be guided along the welding bar 54, in particular the laser beam, during the welding process on the joint 16 portions of the base material of the first and/or second part 2, 3 and the welding bar 54 are completely melted away. The welding bar 54 thus forms a component of the weld 17 to be produced or even forms the complete weld 17. The weld 17 consists solely of the base material to be melted in portions of the parts 2, 3 to be welded and the melted on base material of the welding bar 54.

At this point it should also be noted that the one-piece mounting and positioning projection 6 should not be considered to be conclusive. Equally an embodiment is possible in which the mounting and positioning projection 6 is designed to consist of many parts and the mounting projection 6 and positioning projection 6′ are designed to be separate from one another, as shown in FIG. 28. The mounting projection 6 forms only the mounting surface 7 and the position projection 6′ forms only the positioning surface 14. The mounting and positioning projections 6, 6′ each have a length 10 of between 6 mm and 70 mm. However, it has been shown in practice that the length 10 should be at least double the thickness or sheet thickness of the second part 3. The width of the mounting and positioning projections 6, 6′ corresponds respectively to the thickness or sheet thickness of the second part 3.

According to the embodiment shown the second part 3 in the direction of its longitudinal axis comprises several spaced apart mounting projections 6 and positioning projections, which are arranged on the surface parts 5 running parallel to the longitudinal axis. The mounting projections 6 form the mounting surfaces 7 and the positioning projections 6′ the positioning surfaces 8. The first part 2, as described in FIGS. 1 to 3, comprises the mounting and positioning surfaces 14, 15 associated with the mounting projections 6 and positioning projections 6′, whereby the abutting mounting surfaces 14 of this part 2 with the mounting surfaces 7 of the other part 2 form the joints 16 along which the welds 17 are arranged, and the positioning surfaces 8, 15 of the parts 2, 3 also abut against one another. The mounting and positioning surfaces 7, 8 run in a plane parallel to one another and parallel to the surface parts 5.

In FIGS. 29 and 30 a section of the parts 2, 3, (4), (34) to be welded together and assembly 1 are shown. The parts 2, 3, (4), (34) to be welded together comprise on their facing sides only at least one mounting surface 7, 14 respectively. At least one of the parts 2 comprises only one mounting projection 6 projecting over the surface part 50, which mounting projection forms the mounting surface 7. The parallel mounting surface 14 opposite the mounting surface 7 runs in a plane with the surface part 51. The abutting mounting surfaces 7, 14 form the joint 16. The weld 17 is in the form of a square groove weld or a fillet weld and is designed to be essentially continuous over the entire length of the joint 16. If for example the first part is U-shaped in cross section, the parts 2, 3 are positioned relative to one another so that the second part 3 with the first part 2 in that section of the first part 2 forms the joint 16 in which the dislocation density of the base material is lower than the dislocation density of the joint in a deformation area 18 created on the first part 2 by cold forming, as shown in the preceding Figures. The parts 2, 3 to be welded together are either arranged offset relative to one another in a plane or in a direction perpendicular to the surface parts 50, 51 by an offset, so that between the parts 2, 3, (4), (34) at least on the joint 16 a step is formed, as described above.

The embodiment described here can be transferred to the one in FIGS. 1 to 19, wherein each mounting and positioning projection 6 of the corresponding parts 2 to 4, 34 is formed solely by a mounting projection 6, which only forms the mounting surface 7. The mounting projection 6 has a length 10 of between 6 mm and 70 mm. The length 10 should however be at least double the thickness or sheet thickness of the part 2 on which the mounting projection 6 is formed. The width of the mounting projection 6 corresponds respectively to the thickness or sheet thickness of the part 2. It is an advantage in this embodiment that the weld 17 extends over the entire length of the mounting projection 6 and its start and end sections are rounded so that in the start and end section of the weld 17 there can be an uninterrupted flow of force and any weakening of the supporting weld cross section can be avoided.

Lastly, according to the shown embodiments it is an advantage if the start and end sections of the weld 17 lie remote from the respective deformation area 18 by at least the simple thickness or sheet thickness of a part 2 to 4, 34.

The described welds 17 can run towards one another regardless of the design and arrangement of the parts 2, 3, 4, 34 at a joint 16 from the averted outer sections to its inner section (see FIG. 16). The end sections of the welds 17 can overlap one another or only adjoin one another. In addition, the welds 17 can be arranged at two separate joints 16, wherein the welds 17 run in opposite directions respectively from the outer section to the inner section of the joints 16 (see FIG. 17) or in the same direction from the outer section to the inner section and from the inner section to the outer section of the joints 16 (see FIG. 19). The welds 17 are thus aligned relative to one another and in the direction of a common meeting point lying between the outer sections. The adjacent end sections of the adjoining welds 17 or the meeting point lie in a low-tension section of the assembly 1 or a section that is non critical for its strength properties.

The parts 2, 3, 4, 34 described above are preferably made from the same material, for example from steel or aluminium, and have a tensile strength of 200 N/mm²to 400 N/mm². A reduction in the total weight and advantageous strength properties of the component 1 are achieved, if materials are used which have a tensile strength of 700 N/mm² to 900 N/mm².

It should be noted at this point that by means of the offset 19, 19′, 40, 40′ of the parts 1 to 4, 34 the overlapping width at the joint 16 between the parts 1 to 4, 34 is less than the thickness of the parts 1 to 4, 34. In the case of beam welding hardening occurs in the weld 17, therefore in the melt bath and the base material of the parts 1 to 4, 34 immediately adjacent to the latter. By means of a suitable selection of material for the parts 1 to 4, 34 this hardening process is controlled so that on the one hand a suitable increase in strength is achieved in the weld 17, and on the other hand no hardening cracks appear in the weld 17. This means that the weld 17 never cracks under normal loading conditions, as despite the lower weld cross section the mechanical load-bearing ability of the weld 17 is always greater than the mechanical load-bearing ability of the surrounding base material of parts 1 to 4, 34. It is now entirely possible to opt for an increase in strength in the region of the joint 16 or weld 17 of between 50% and 300%.

Although only sheet metal parts are shown in the Figs. it is also possible within the scope of the invention for at least one of the parts to be formed by a forged part for example, which is produced accurate to size by cold forging (cold forming). Like-wise one of the parts can be formed by a solid formed part, for example a forged part which is produced accurate to size by hot or cold forging.

In the following the method for production of an assembly 1 according to the invention is described in more detail.

Firstly, the parts 2 to 4, 34 are cut out of a flat sheet metal piece, in particular stamped out, and if necessary are shaped by bending into their appropriate shape. If the part is a forged part, the latter is shaped into its appropriate shape at room temperature by forging. It is essential that the mounting and/or positioning surfaces 7, 14, 8, 15 are produced with high precision. In contrast the remaining surface parts which adjoin the mounting and/or positioning projections 6 or mounting and/or positioning surfaces 6, 14, 7, 15 can be produced with low precision. The parts 3 to 4, 34 that are worked accurately to size before joining together or welding are held fixed in a welding system by means of clamping tools of clamping and positioning devices (not shown), and are positioned/aligned relative to one another by means of adjusting devices (not shown) and are pressed against one under prestressing force on their corresponding, preferably parallel, planar mounting and/or positioning surfaces 7, 14, 8, 15. After this the parts 2 to 4, 34 are joined together so as to be undetachable by means of beam welding, in particular laser or electron beam welding, at the joint 16 by melting sections of the base material of the parts 2 to 4, 34 to be welded. The prestressing force remains preferably constant during the entire welding procedure, as the parts 2, 3, 4, 34 to be welded are supported relative to one another always with their mutually allocated mounting and/or positioning surfaces 7, 14, 8, 15.

Often during the production of the assembly 1 according to the invention the problem arises that the individual parts 1 to 4, 34 produced by shaping do not have the precise shape required of them. For example, during bending to achieve precision shaping account needs to be taken of the rebounding tendency of the shaped sheet metal section.

In the following a method for producing the assembly 1 according to the invention is described with reference to FIGS. 31 and 32, in which this imprecise shaping is reduced to a permissible limit.

To perform this method a welding system is provided, which comprises a schematically illustrated first clamping and positioning device 56 for the first part 2 that is cut to size and if necessary shaped or is only shaped, a welding device 58, a holder 59 for at least one second part 3 that is cut to size and if necessary shaped or is only reshaped, and a second clamping and positioning device 60 for the second part 3.

The first clamping and positioning device 56 for mounting, positioning and clamping the first part 2 as required comprises at least two, in the embodiment shown for example three separately activated clamping tools 57, 57′, 57″, in particular collets with adjustable clamping elements. One of the clamping tools 57 clamps or holds the U-shaped part 2 on the base 11, whilst the two other clamping tools 57′, 57″ clamp or hold one leg 12 respectively, so that the part 2 can be fixed in position or in its desired shape. Imprecisions in the measurements, such as for example the internal width between the legs 12, on the part 2, which would have a negative effect on the overall precision of the assembly 1, are compensated effectively by the specific control of the clamping tools 57, 57′, 57″. For this purpose, the clamping and positioning device 56 comprises adjusting devices 66, 66′, 66″ driven by steplessly controllable servo drives, with which the clamping tools 57, 57′, 57″ can be moved or positioned as desired in space. For example, each clamping tool 57, 57′, 57″ is mounted on a slide of the adjusting device 66, 66′,66″ that can be moved or positioned as desired in space preferably by means of steplessly controllable servo drives. As also not shown, in addition the entire first clamping and positioning device 56 is mounted on a slide that is adjustable by means of an adjusting device driven by a steplessly controllable servo drive, so that the first clamping and positioning device 56 can be moved or positioned horizontally in space at least in the direction of the second clamping and positioning device 60. This adjusting device, in particular the servo drive, is connected to a control 67.

The second clamping and positioning device 60 for mounting, positioning and clamping the second part 3 as required comprises at least one controllable clamping tool 63, in particular collet, with adjustable, in particular radially moveable clamping elements, as indicated only schematically by arrows. The sleeve-shaped, second part 3 is clamped by means of the clamping tool 63 on a surface part 68 or inner casing surface, as indicated only schematically in FIG. 31 by arrows. Imprecisions in the dimensions, such as for example the inner diameter, on part 3, which would have negative effects on the overall precision of the assembly 1, are compensated effectively by the specific control of the clamping tool 63. For this purpose, the clamping and positioning device 60 has an adjusting device 61 driven by steplessly controllable servo drives with which adjusting device the clamping tool 63 can be moved or positioned as desired in space. For example, the clamping tool 63 is mounted on a slide of the adjusting device 61 that can be moved or positioned as desired in space preferably by means of steplessly controllable servo drives. As also not shown, in addition the entire second clamping and positioning device 56 is mounted on a slide that is adjustable by means of an adjusting device driven by a steplessly controllable servo drive, so that the first clamping and positioning device 56 can be moved or positioned horizontally in space at least in the direction of the second clamping and positioning device 60. This adjusting device, in particular the servo drive, is connected to a control 67.

The clamping tools 57, 57′, 57″, 63, in particular the clamping elements, the clamping and positioning devices 56, 60 are designed to be adjustable by means of the adjusting drives between an inactivated initial position, as indicated in FIG. 31 by a solid line for the clamping tool 63, and a shaping activated position, as shown in FIG. 31 by a broken line for the clamping tool 63′. In the initial position the clamping surfaces of the clamping tools 57, 57′, 57″, 63 are arranged spaced slightly apart from the inner and/or outer surface parts of the part 2 or from the inner or outer casing surface of the part 3 and in the activated position the clamping surfaces are pressed against the inner and/or outer surface parts of the part 2 or inner or outer casing surface of the part 3.

As the clamping and positioning devices 56, 60, in particular the clamping tools 57, 57′, 57″, 63 can be positioned as desired in space, both parts 2, 3 can now be moved towards one another and positioned or aligned relative to one another in radial direction. However, the first clamping and positioning device 56 positionable in space can be arranged equally well on a fixed frame part of the welding system, so that only the second part 3 can be moved relative to the first part 2. The first part 2 is in this case held only in position or in its desired shape by the clamping tools 57, 57′, 57″, but not moved in the direction of the second part 3.

The clamping elements of the clamping tools 57, 57′, 57″, 63 for the clamping and positioning devices 56, 60 can be activated respectively by means of an actuator, for example hydraulically, pneumatically, mechanically or electrically. The actuator for the clamping tool 63 of the second clamping and positioning device 60 is denoted by 65 and the actuators for the clamping tools 57, 57′, 57″ of the first clamping and positioning device 56 are denoted by 74, 74′, 74″. For the controlled application of force on the first and/or second parts 2, 3 by the clamping tools 57, 57′, 57″, 63 of the first and/or second clamping and positioning device 56, 60, the latter are provided respectively with a device for determining the force exerted on the first and/or second part 2, 3 for shaping the latter.

Lastly, the welding device 58 is also mounted on an adjusting device 62 that can be positioned as desired in space. For example, the welding device 58, for example a laser or electron welding head, is mounted on a slide of the third adjusting device 62 that can be moved or positioned as desired in space by means of steplessly controllable servo drives.

The servo drives of the adjusting devices 61, 62, 66, 66′, 66″ and the actuator 65, 74, 74′, 74″ of the clamping elements are connected to the preferably electronic control 67 for the welding system, which in turn comprises a computer system and a controller and drives the servo drives and actuators.

As also included in FIG. 32 in a further embodiment the welding system comprises at least one measuring device 64, which is provided preferably in a plane running between the two parts 2, 3 to be welded together. Said measuring device 64 is formed by an electromechanically operating or opto-electronic measuring system. The latter comprises at least one optical sensor for detecting without contract the actual shape of at least one of the part 2, 3 and can be formed for example by a laser or infrared measuring system or CCD camera and the like. The electromechanically operating measuring system is formed for example by a measuring sensor by which the actual shape is detected of at least one of the parts 2, 3. The measuring system is either provided in the welding system in the vicinity of the clamping and positioning devices 56, 60 or outside the welding system. According to the latter embodiment for example the part 3 mounted on the holder 59 is transported past the measuring system or held for a brief period and measured, as described in the following, and then transported into the welding system into a preparation position between the clamping and positioning devices 56, 60.

The holder 59 described above is either arranged to be stationary between the two clamping and positioning devices 60 arranged spaced apart from one another or is adjustable relative to the clamping and positioning devices 56, 60 via a transport system.

The measuring device 64 is also connected to the control 67 for the welding system which in turn comprises the computer system and the controller, and drives the actuators 65, 74, 74′, 74 depending on the comparison of desired/actual values between the actual values detected by the measuring device 64 and the desired values for the dimensions stored in the control 67.

It has been shown in practice that the sleeve formed by a section of a pipe shaped and welded from a flat sheet metal piece or by deep-drawing or stretching can be produced inexpensively, but the result is a greater number of imprecise measurements than in manufacture by chipping and therefore only an insufficiently precise mount for a bearing 44 (not shown) can be provided. Mostly the sleeve is oval in cross section, as shown in FIG. 31 by a solid line, so that the round properties and the rolling friction for example of a roller bearing are impaired after pressing into the sleeve. Consequently, in every section plane perpendicular to the longitudinal axis 69 the tolerated casing line between two concentric circles must lie be a distance t=0.05 mm.

If the sleeve itself is used as a bearing ring the requirements for precision are even greater, as the ball race of the roller bearing is now a component of the sleeve, preferably produced without chippings. The tolerated spacing is thus about t=0.02 mm.

On the basis of this finding by means of the specific shaping of this “imprecise” sleeve a degree of precision is achieved which meets the requirements for a precise bearing mount or roller body track.

The assembly 1 according to the invention can be produced in several consecutive working steps according to two embodiments. The assembly 1 is in this embodiment composed from a U-shaped, first part 2 and a sleeve to be welded onto the front side of the latter as a second part 3.

### First Embodiment

Firstly, the first part 2 is provided, for example by means of a transport system to a preparation position and there is mounted, positioned, fixed and aligned on the first clamping and positioning device 56 by means of the clamping tools 57, 57′, 57″ (thus made into to the desired shape). Consequently, the tolerated spacing between each leg 12 and the gravity axis running perpendicular to the base 11 has to be in each section plane perpendicular to the gravity axis in the region of t=0.1 mm. In other words, the base 11 and the leg 12 run in two planes, which enclose an angle of 90°, whereby a tolerated angular deviation can be in the region of 0.5°. This applies to the design of the first part 2 with a U-shaped or L-shaped cross section.

Whilst the first part 2 is positioned, fixed and aligned, the second part 3 is moved into a preparation position between the first and second clamping and positioning device 60, for example conveyed by the transport system or placed on the fixed holder 59. The second part 3 is mounted freely or held on the holder 59.

Afterwards, the second part 2 is mounted by the clamping tool 63, positioned relative to the latter and shaped cylindrically by the application of force into the desired shape, in particular slightly widened. The application of force is performed by means of the clamping elements driven by the actuator 65 with curved clamping surfaces, which can be placed against the inner casing surface of the second part 2. As according to the first embodiment the shaping of the second part 2 into the desired shape is performed without a measuring step, the clamping elements are controlled by the actuator so that the maximum tolerance deviation known from the production of the welded pipes is overcome reliably and the sleeve-shaped, second part 2 is shaped into a precisely cylindrical desired shape.

The positioning and centring of the part 3 on the clamping tool 63 is performed in an advantageous manner so that firstly only individual clamping elements are pressed with low force against the inner casing surface and the first front side surface part 33 facing away from the first part 2 is positioned against a reference surface 70 of a support plate 71 comprising the clamping and positioning device 60, in particular the clamping tool 63. Afterwards the part 3 is shaped into the desired shape by the radial application of force against the casing surface. The second part 3 is positioned and centred on the clamping tool 63 essentially without play in the direction of the longitudinal axis 69 and in a direction radial to the longitudinal axis 69. This positioning permits careful handling of the part 3.

The second part 3 is then centred of positioned in this precise cylindrical desired shape on the clamping tool 63. Afterwards the parts 2, 3 are aligned relative to one another by activation of at least one or all of the adjusting devices 61, 66, 66′, 66″ for the clamping tools 57, 57′, 57″, 63 and moved towards one another by activating at least one or both adjusting devices for the clamping an positioning devices 56, 60 and with their facing mounting and/or positioning surfaces 7, 8, 14, 15 are placed against one another essentially without a gap. In a different embodiment the second part 3 is aligned relative to the first part 2, moved towards the positioned, precisely shaped first part 2 and with its mounting and/or positioning surfaces 14, 15 facing the mounting and/or positioning surfaces of the first part 2 is positioned essentially without play.

As already described above, the mounting and positioning surfaces 7, 8, 14, 15 can be formed either by the facing, front side surface parts 27, 28 (not entered) of the parts 2, 3 or by not shown mounting and if necessary positioning projections 6, 6′ projecting over the first part 2 on its surface part 27 facing the second part 3 and the mounting and if necessary positioning surface 14, 15 on the second part 3 lying in a plane with the surface part 28. It is also possible within the scope of the invention however that the parts 2, 3 to be welded only form mounting surfaces 7, 14. The latter run respectively with the surface parts 27, 28 in a plane or are formed by not shown mounting projections 6 projecting over the first part 2 on its surface part 27 facing the second part 3 and the mounting surface 14 on the second part 3 lying in a plane with the surface part 28.

In order to achieve a reliable securing of the two parts 2, 3 it is provided that the mounting and/or positioning surfaces 7, 8, 14, 15 are pressed against one another with a prestressing force. The parts 2, 3 clamped in the clamping tools 57, 57′, 57″, 63 and abutting against one another at the mounting and/or positioning surfaces 7, 8, 14, 15 are moved towards one another for so long or pressed against one another so tightly until the continually building up prestressing force between the parts 2, 3 reaches a minimum value. The level of the prestressing force and/or the movement of the first and if necessary second clamping and positioning device 56, 60 can preferably be evaluated by the power consumption of the servo drive of the adjusting device(s) for all the clamping and positioning devices 56 and/or 60. In this way a controlled securing of the parts 2, 3, can be achieved.

Once the two parts 2, 3 are secured to one another correctly the welding device 58 is activated by the control 67, which is now moved by means of the adjusting device 62, whereby a not shown weld 17 is placed on the joint or joints 17 and the parts 2, 3 are welded. The clamping devices 56, 60 are preferably held still during the welding process. Once the parts 2, 3 have been welded the finished assembly 1 is again placed on the holder 59 and the clamping tools 57, 57′, 57″, 63 are released, in that tightening elements are moved away from the surface parts of the parts 2, 3. Afterwards the assembly 1 is transported out of the welding system.

### Second Embodiment

In a first stage both parts 2, 3 are provided, for example conveyed by means of a transport system to the readiness positions.

After this on the face end side of the first and/or second part 2, 3, in the embodiment shown for reasons of simplicity of the second part 3, the actual shape—therefore the roundness—is determined electronically by a laser measuring system. In this case the parts 2, 3 can still be in the readiness positions and the measurement is carried out before they are taken by the clamping tools 57, 57′, 57″, 63, positioned on the latter and fixed, or the measurement is only performed once they have been mounted on the clamping and positioning devices 56, 60 by the clamping tools 57, 57′, 57″, 63, positioned on the latter and fixed. The actual values of the dimensions (actual shape) are transferred to the control 67. In the computer system of the control 67 desired shapes or values for the dimensions are stored for different dimensions/geometries of the parts 2 and/or 3. Now the actual values of the dimensions are fed into the control unit and then in the control 67 a desired/actual comparison of the desired and actual values of the dimensions is carried out.

If the actual values of the dimensions lie within a reliable tolerance range for the desired values of the dimensions, the adjusting device of the first clamping and positioning device 56 and/or the adjusting device of the second clamping and positioning device 60 is driven by the control, which moves the parts 2, 3, secured by the clamping tool 57, 57′, 57″, 63 towards one another and then welds them.

If however the measuring device 64 detects a deviation of the actual shape from the desired shape in at least one dimension, the actual values of the dimensions on the first and/or second part 2, 3 are established and transmitted to the control 67. By way of the deviation calculated from the desired/actual value comparison of the dimensions a correction value is determined by the control unit or control 67. Depending on this correction value one or more adjusting devices 61, 66, 66′, 66″ and/or one or more actuators 74, 74′,74″, 65 for the clamping elements of the clamping tool(s) 57, 57′, 57″, 63 of the first and/or second clamping and positioning device 56, 60 are activated. The corresponding correction value is entered into an electronic control of the servo drive(s) of the adjusting device(s) 61, 66, 66′, 66″ and/or the actuator(s) 74, 74′, 74″, 65 for the clamping elements of the clamping tool(s) 57, 57′, 57″, 63 of the first and/or second clamping and positioning device 56, 60.

The clamping elements of the clamping tool 57′, 57″ for the first part 2 are shaped radially by way of the correction value calculated by the control 67 relative to the gravity axis running perpendicular to the base 11 and/or the clamping elements of the clamping tool 63 for the second part 3 are shaped radially by way of the correction value calculated by the control 67 in relation to the longitudinal axis 69, so that the incorrect shape of the first and/or second part 2, 3 is adjusted by shaping the latter until a desired shape is obtained

Once the correction value has been adjusted and the first and/or second part 2, 3 shaped into the desired shape, the adjusting movement of the clamping tools 57, 57′, 57″, 63 or the clamping elements is stopped and the force established thereby is kept constant.

Once the parts 2, 3 positioned on the clamping tools 57, 57′, 57″, 63 have been aligned relative to one another, moved towards one another, and with their facing mounting and/or positioning surfaces 7, 8, 14, 15 have been placed gap-free against one another and pressed against one another with a prestressing force, the parts 2, 3 are welded at the not shown joints 16, as described above.

It is essential that during the entire alignment and positioning process of the parts 2, 3 relative to one another, the force loading of the clamping tools 57, 57′, 57″, 63 on the parts 2, 3 is maintained constantly and is lifted only after the welding procedure.

It is also possible for the parts 2, 3 already maintained in the desired shape and/or shaped into the desired shape, once they have been aligned relative to one another and pressed against one another with a prestressing force and before they are welded together, that the actual shape is again determined and in the case of any deviation from the desired shape a subsequent reshaping takes place so that the desired shaped is reliably obtained.

It is also possible for the actual shape to be established again after welding and in the case of any incorrect deformation of one of the parts 2, 3 due to the internal stresses of welding, the assembly 1 is ejected form the welding system as a reject part.

In a preferred design however, during the entire shaping procedure of the part 2, 3 there is a continuous comparison of the desired and actual value of the dimensions, whereby a high degree of processing reliability and permanent quality control is possible.

In the embodiments described above it is assumed that the shaping process of at least one part 2, 3 into its desired shaped takes place before the parts 2, 3 are aligned and positioned relative to one another. It is also possible that the measuring device 64 determines the actual shape or the actual values of the dimensions of the parts 2, 3, calculates the position of their longitudinal axis 69, 72, and the clamping tools 57, 58′, 57″, 63 of the clamping and positioning devices 56, 60 with the parts 2, 3 located thereon are adjusted in dimension such that the longitudinal axes 69, 72 of the parts form a common axis. Afterwards the parts 2, 3 are moved towards one another, placed on top of one another with their mounting and/or positioning surfaces 7, 8, 14, 15 and then the part 2, 3 that deviates from its desired shape is shaped until its actual shape is adjusted to the desired shape. Once the shape deviation has been adjusted the welding procedure takes place on the not entered joints 16 between the first and second part 2, 3.

Of course, these embodiments are not restricted to the design of the second part 3 in the form of a sleeve, but rather any profile is possible which is subjected to shaping. For example the second part 3 can have a trapezoid, U-shaped or L-shaped cross section. The first part 2 can be formed by a flat metal piece but also by a shaped profile. The clamping tool 57, 57′, 57″, 63 is adjusted accordingly.

Depending on the degree of shaping or deviation between the actual and desired shape of the first and/or second part 3 the latter is shaped either plastically and/or elastically at least in part sections.

The assembly 1 produced according to this method is characterised by its high measurement precision and its simple manufacture.

The embodiments show possible embodiment variants of the assembly 1, whereby it should be noted that the invention is not restricted to the embodiments shown in particular, but rather various combinations of the individual embodiment variants are possible and this variability can be achieved by a person skilled in this technical field on the basis of the teaching on technical procedure of the present invention. Also all conceivable embodiment variants, which are possible by combining individual details of the shown and described embodiment variants, are also covered by the scope of protection.

For form's same it should be pointed out that for a better understanding of the structure of the assembly 1 the latter and its components have not always been represented to scale and/or have been enlarged and/or reduced in size.

The objective forming the basis of the independent solutions of the invention can be taken from the description.

Mainly the individual embodiments shown in FIGS. 1 to 32 can form the subject matter of independent solutions according to the invention. The objectives and solutions of the invention relating thereto can be taken from the detailed descriptions of said Figures.

### LIST OF REFERENCE NUMERALS

1 Assembly
2 Part
3 Part
4 Part
5 Surface part
6 Mounting and positioning projection
6′ Positioning projection
7 Mounting surface
8 Positioning surface
9 Height
10 Length
11 Base
12 Leg
13 Surface part
14 Mounting surface
15 Positioning surface
16 Joint
17 Weld
17′ Weld
18 Deformation area
19 Offset
19′ Offset
20 Surface part
21 Surface part
24 Bearing eye
26 Axis
27 Surface part
28 Surface part
29 Surface part
30 surface part
31 Surface part
32 Surface part
33 Surface part
34 Part
35 Surface part
36 Surface part
37 Surface part
38 Surface part
39 Surface part
40 Offset
40′ Offset
41 Gravity axis
42 Gravity axis
43 Support surface
44 Bearing
45 Surface part
46 Surface part
47 Surface part
48 Surface part
49 Surface part
50 Surface part
51 Surface part
52 Surface part
53 Surface part
54 Welding bar
55 Height
55′ Width
56 Clamping and positioning device
57 Clamping tool
57′ Clamping tool
57″ Clamping tool
58 Welding device
59 Holder
60 Clamping and positioning device
61 Adjusting device
62 Adjusting device
63 Clamping tool
64 Measuring device
65 Actuator
66 Adjusting device
66′ Adjusting device
66″ Adjusting device
67 Control
68 Surface part
69 Longitudinal axis
70 Reference surface
71 Support plate
72 Longitudinal axis
74 Actuator
74′ Actuator
74″ Actuator

1-53. (canceled)

54. Assembly (1) consisting of at least one first and second metal part (2, 3), of which at least the first part (2) is subjected to cold forming, in particular bending or cold forging, and the parts (2, 3) have first surface parts (20, 21; 29 to 32; 29, 31, 37, 39, 46; 52, 53) that are parallel to one another in sections and corresponding mounting surfaces (7, 14) running at an angle, in particular at right angles to the latter for their mutual arrangement essentially without a gap, and the first surface parts (20, 21; 29 to 32; 29, 31, 37, 39, 46; 52, 53) are arranged offset relative to one another by an offset (19, 19′) in the direction of a plane defined by the mounting surfaces (7, 14), so that the parts (2, 3) to be welded together at least on at least one joint (16) formed by the mounting surfaces (7, 14) of the parts (2, 3) contacting one another without a gap form a step, and on at least one part (2, 3) the mounting surface (7, 14) is formed by at least one mounting projection (6) projecting over a second surface part (5; 27; 37, 39; 50), and the parts (2, 3) are joined together by at least one weld (17) produced by beam welding, in particular laser or electron beam welding, on the joint (16) formed by the mounting surfaces (7, 14) of the parts (2, 3) contacting one another without a gap, wherein the weld (17) consists of base material partly melted from the parts (2, 3) to be welded together in sections and the weld (17) is designed as a square-groove weld or fillet weld and is essentially continuous over the entire length of the joint (16), wherein the mounting surface (7, 14) on the mounting projection (6) is largely parallel to the second surface part (5; 27; 37; 39; 50) and wherein the parts (2, 3) are positioned relative to one another so that the second part (3) forms the joint (16) with the first part (2) in that section of the first part (2) in which a dislocation density of the base material is lower than the dislocation density of the joint in a deformation area (18) formed on the first part (2) by cold forming, and wherein the offset (19, 19′) between the first surface parts (20, 21; 29 to 32; 29, 31, 37, 39, 46; 52, 53) is between 5% and 50% of the maximum thickness of a part (2, 3).

55. Assembly (1) according to claim 54, wherein the first part (2) in a plane perpendicular to its longitudinal extension has a profile-like, in particular essentially U-shaped or trapezoid cross section, and first surface parts (37, 39) on its outer casing, and the second part (3) is designed as a sleeve with a circular-shaped cross section in a plane perpendicular to its longitudinal extension and its outer circumference forms its first surface part (36), wherein the first surface parts (36, 37, 39) of the parts (2, 3) pointing in the same direction are arranged offset relative to one another by an offset (40, 40′) in the direction of a plane defined by the mounting surfaces (7, 14), so that the parts (2, 3) to be welded together at least at the joints (16) formed by the mounting surfaces (7, 14) of the parts (2, 3) contacting one another without any gap form a step respectively, wherein both parts (2, 3) on their facing front sides respectively comprise the mounting surfaces (7, 14) respectively and between the first part (2) and the second part (3) at least separate joints (16) are formed.

56. Assembly according to claim 54, wherein the parts (2, 3) to be welded together on their facing sides respectively have at least one mounting surface (7, 14) and in addition at least one positioning surface (8, 15) parallel to the mounting surface (7, 14), wherein on at least one part (2, 3) the mounting and/or positioning surface (7, 8, 14, 15) of at least one mounting and/or positioning projection (6; 6′) is formed, and wherein the parts (2, 3) are aligned relative to one another and positioned by their facing positioning surfaces (8, 15).

57. Assembly according to claim 55, wherein a third part (4) is provided which is produced by stamping and/or cold forming, in particular bending or cold forging, which is designed as a sleeve with a circular-shaped cross section in a plane perpendicular to its longitudinal extension and is also joined to the profile-like part (2), wherein the sleeves are arranged on opposite face ends of the profile-like part (2) and their axes (26) form a common axis, and wherein the profile-like part (2) on its opposite face ends respectively has at least two mounting surfaces (7) and in addition at least two positioning surfaces (8) parallel to the mounting surfaces (7) and the sleeves in turn on their side facing the face end of the profile-like part (2) have at least two mounting surfaces (14) and in addition at least two positioning surfaces (15) parallel to the mounting surfaces (14), and wherein the sleeves and the profile-like part (2) are positioned relative to one another and aligned by their facing positioning surfaces (8, 15), and each sleeve is connected by welds (17) produced by beam welding at at least two joints (16) formed separately by the mounting surfaces (7, 14) of the parts (2, 3, 4) that contact one another without a gap, and each weld (17) is in the form of a square-groove weld or fillet weld and is formed essentially over the entire length of the relevant joint (16).

58. Assembly according to claim 55, wherein the profile-like part (2) has two legs (12) and a base (11) connecting the latter and on the face ends in turn forms the face side second surface parts (27) facing away from one another, wherein on the second surface parts (27) of the legs (12) and if necessary the base (11) respectively at least one mounting surface (7) and at least one positioning surface (8) parallel to the mounting surfaces (7) are arranged.

59. Assembly according to claim 55, wherein a fourth part (34) is provided which is produced to be essentially flat by stamping and/or cold forming, in particular bending or cold forging, which is connected to the legs (12) of the profile-like part (2), and on the lateral second surface parts (5) facing the legs (12) respectively has at least two mounting surfaces (14) or on the lower surface part (48) facing the two legs (12) has at least two mounting surfaces (7) and in addition at least two positioning surfaces (8) parallel thereto, and the legs (12) on the surface parts (13; 47) facing the fourth part (34) are provided respectively with at least two mounting surfaces (8) and in addition at least two positioning surfaces (15) parallel to the latter, and wherein the parts (2, 34) via their facing positioning surfaces (8, 15) are positioned relative to one another and aligned and are connected by welds (17) produced by beam welding, in particular laser or electron beam welding, onto at least two joints (16) formed separately by the mounting surfaces (7, 14) of the parts (2, 34) contacting one another without a gap, wherein each weld (17) is designed to be a square-groove weld or fillet weld and is essentially continuous over the entire length of the relevant joint (16), and/or wherein the surface parts (37) formed on the legs (12) and lateral first surface parts (49) formed on the fourth part (34) parallel to the surface parts (20) are arranged to be mutually offset by an offset (19) in the direction of a plane defined by the mounting surfaces (7, 14), so that the parts (2, 34) to be welded together form a step at least at the joints (16), wherein said offset (19) is between 5% and 50% of the maximum thickness of a part (2, 34).

60. Assembly according to claim 57, wherein the fourth part (34) on its mutually averted face end second surface parts (35) respectively has at least one mounting surface (7) and in addition at least one positioning surface (8) parallel to the latter and each of the sleeves on the surface part (28) facing the face end surface part (35) of the fourth part (34) has at least one mounting surface (14) and in addition at least one positioning surface (15) parallel thereto, and is connected to the fourth part (34) by a weld (17) formed by beam welding, in particular laser or electron beam welding, at at least one joint (16) formed by the mounting surfaces (7, 14) contacting one another without a gap, wherein the weld (17) is in the form of a square groove weld or fillet weld and is continuous over the entire length of the joint (16), wherein the sleeves and the fourth part (34) are positioned relative to one another and aligned by the mutually aligned positioning surfaces (8, 15) and/or wherein the first surface parts (36, 21) of the parts (3, 4, 34) pointing in the same direction are arranged offset relative to one another by an offset (40′) in the direction of a plane defined by the mounting surfaces (7, 14), so that the parts (3, 4, 34) to be welded together form a step at least at the joint, and the axes (26) of the sleeves form a common axis and the offset (40′) is between 5% and 50% of the maximum thickness of a part (3, 4, 34).

61. Assembly according to claim 59, wherein the averted face end second surface parts (35) of the fourth part (34) close flush with the second surface parts (27) of the profile-like part (2).

62. Assembly according to claim 59, wherein the mounting and/or positioning surfaces (7, 8) on the averted face end second surface parts (27) of the profile-like part (2) and the mounting and/or positioning surfaces (14, 15) on the averted face end second surface parts (35) of the fourth part (34) are arranged in planes running perpendicular to the longitudinal direction of the profile-like part (2).

63. Assembly according to claim 55, wherein the parts (2, 3, 4, 34) are aligned relative to one another by their mutually arranged positioning surfaces (8, 15) and/or are positioned relative to one another so that the second and third part (3, 4) with the first and/or fourth part (2) in each section of the first and/or fourth part (2) respectively forms the at least one joint (16), in which the dislocation density of the base material is lower than the dislocation density of the joint in a deformation area (18) formed on the first and/or fourth part (2) by cold forming.

64. Assembly (1) consisting of at least two metal parts (2, 3), which are provided with corresponding mounting surfaces (7, 14) for arranging them relative to one another essentially without a gap, and are to be joined together via at least one weld (17) produced by beam welding, in particular laser or electron beam welding, at at least one joint (16) formed by the mounting surfaces (7, 14) of the parts (2, 3) arranged next to one another without a gap, wherein the weld (17) is formed by the base material that is melted in sections from the parts (2, 3) to be welded together, and at least one of the parts (2, 3) has at least one welding bar (54) which adjoins the mounting surface (7, 14) and can be melted by a welding beam, in particular laser or electron beam, which is formed onto this part (2, 3) and is provided for forming a least one component of the weld (17) to be produced, wherein welding bar (54) projects over a positioning surface (8) formed by the first part (2) in the direction of the second part (3) opposite the first part (2), whereby the positioning surface (8) runs parallel to the mounting surface (7).

65. Assembly according to claim 64, wherein the welding bar (54) extends essentially over the entire length of the joint (16) or the edge to be formed by the mounting surfaces (7, 14) of the parts (2, 3) that contact one another without a gap.

66. Assembly according to claim 64, wherein the welding bar (54) has a height (55) and width (55′) corresponding to about 5% to 50% of the maximum thickness of a part (2, 3).

67. Assembly according to claim 54, wherein the mounting and positioning surfaces (7, 8, 14, 15) are formed on a part (2, 3, 4, 34) or parts (2, 3, 4, 34) in the same plane.

68. Assembly according to claim 54, wherein two parts (2, 3, 4, 34) are connected together by at least two welds (17) on at least two separately formed joints (16), wherein the welds (17) respectively are in the form of a square-groove weld or fillet weld extending at the joints (17) essentially continuously over their entire length.

69. Assembly according to claim 54, wherein on at least one of the parts (2, 3, 4, 34) at least one mounting and positioning projection (6; 6′) is formed, which forms the mounting and/or positioning surface (7, 8, 14, 15) and on a second surface part (5; 27; 37; 47; 50) of the first part (3; 2) parallel to the mounting surface (7, 14) projects in the direction of the other part (2; 3).

70. Assembly according to claim 54, wherein the surface part (13), the mounting and positioning surfaces (14, 15) of the first part (2; 3; 4) are arranged in one plane and the other part (3; 2) comprises at least one mounting and/or positioning projection (6, 6′) allocated to the mounting and/or positioning surface (14, 15).

71. Assembly according to claim 55, wherein the surface part (50, 51), the mounting and positioning surfaces (7, 8, 14, 15) of each of the parts (2, 3, 4, 34) to be welded are arranged lying in one plane.

72. Assembly according to claim 54, wherein the mounting and positioning surfaces (7, 8, 14, 15) are immediately adjacent to one part or parts (2, 3, 34) to be welded and are formed by a mounting and/or positioning projection (6).

73. Assembly according to claim 54, wherein the mounting and positioning surfaces (7, 8, 14, 15) on one part or parts (2, 3, 4, 34) to be welded are separated from one another spatially and are formed respectively by a mounting projection (6) and a positioning projection (6′).

74. Assembly according to claim 57, wherein the sleeves form bearing eyes (24), in which bearings (44) are arranged, in particular pressed in, by means of which a shaft is mounted rotatably.

75. Assembly according to claim 55, wherein an internal diameter of the sleeve is greater than the distance between the legs (12) and the sleeve on the planar mounting surfaces (7) of at least two joints (16) delimits circle sections, which form support surfaces (43) against which the bearing (44) is positioned.

76. Assembly according to claim 54, wherein the opposite parts (2, 3, 4, 34) to be welded together comprise respectively at least one mounting and/or positioning projection (6, 6′), which forms the mounting and/or positioning surface (7, 8, 14, 15) and is formed on each part (2, 3, 4, 34), wherein the mounting and/or positioning projection (6; 6′) of the first part (2, 3, 4, 34) of its surface part (50, 51) facing the other part (2, 3, 4, 34) projects in the direction of the other part (2, 3, 4, 34) and the mounting and/or positioning projection (6; 6′) of the other part (2, 3, 4, 34) projects from its surface part (50, 51) facing the first part (2, 3, 4, 34) in the direction of the first part (2, 3, 4, 34), and the mounting and/or positioning projection (6; 6′) of the first part (2, 3, 4, 34) and mounting and/or positioning projection (6; 6′) of the other part (2, 3, 4, 34) run towards one another and contact one another essentially without a gap with their mounting and/or positioning surfaces (7, 8, 14, 15).

77. Assembly according to claim 54, wherein the mounting and/or positioning projection (6; 6′) has a length corresponding approximately to double the thickness of a part (2, 3, 4, 34).

78. Assembly according to claim 54, wherein the mounting and/or positioning projection (6; 6′) has height (9) which is between 5% and 50% of the thickness of a part (2, 3, 4, 34).

79. Assembly according to claim 54, wherein the mounting and positioning surfaces (7, 8, 14, 15) of at least one of the parts (2, 3, 4, 34) to be welded lie in two planes and enclose an angle of preferably 90°.

80. Assembly according to claim 54, wherein the parts (2, 3, 4, 34) to be welded are arranged in two planes and enclose an angle of preferably 90°.

81. Assembly according to claim 54, wherein the parts (2, 3) to be welded with their mounting and positioning surfaces (7, 8, 14, 15) lie on top of one another in a butt joint and are arranged offset relative to one another about the offset (19) in a direction perpendicular to their surface parts (52, 53).

82. Assembly according to claim 54, wherein two parts (2, 3, 4, 34) are joined together via two welds (17) on two separate joints (16) that run towards one another and are produced in opposite welding direction, wherein adjacent end sections of the welds (17) lie in a low-tension or non critical section of the assembly (1).

83. Assembly according to claim 54, wherein two parts (2, 3, 4, 34) are connected at a joint (16) by at least two welds (17) that run from its outer sections to its inner section and are produced in opposite welding direction, wherein adjacent end sections of the welds (17) lie in a low-tension or non critical section of the assembly (1).

84. Assembly according to claim 82, wherein the welds (17) are directed towards one another and in a direction towards a common meeting point, wherein the end sections of the welds (17) overlap with one another at the common meeting point.

85. Assembly according to claim 82, wherein the welds (17) are directed towards one another and in the direction of a common meeting point, wherein the end sections of the welds (17) end at the common meeting point.

86. Assembly according to claim 85, wherein the meeting point lies in a low-tension or non critical section of the assembly (1).

87. Assembly according to claim 54, wherein two parts (2, 3, 4, 34) are connected together by two welds (17) running towards one another and produced in the same welding direction at two separate joints (16), wherein adjacent end sections of the welds (17) lie in a low-tension or non critical section of the assembly (1).

88. Assembly according to claim 54, wherein an end section of the at least one weld (17) is placed on a mechanically less stressed section of the assembly (1) and an initial section of the at least one weld (17) is placed on a mechanically more stressed section of the assembly (1).

89. Assembly according to claim 54, wherein the joint (16) or the joints (16) and the at least one weld (17) on the joint (16) or on the joints (16) are arranged between the parts (2, 3, 4, 34) in a low-tension or non critical section of the assembly (1).

90. Method for producing an assembly (1) according to claim 54, with a metal, first part (2) and at least one metal second part (3), shaped to form a profile, in which on both parts (2, 3) respectively at least one mounting surface (7, 14) is formed, whereupon the parts (2, 3) are fixed respectively by means of at least one clamping tool (57, 57′, 57″, 63) by the clamping and positioning devices (57, 60) and positioned relative to one another, and are pressed against one another on their corresponding mounting surfaces (7, 14) and afterwards are joined together by means of beam welding, in particular laser or electron beam welding, at at least one joint (16) formed by the mounting surfaces (7, 14) of the parts contacting one another without any gap by melting the base material in sections, wherein the first part (2) is secured by means of the clamping tool (57, 57′, 57″ ) of the first clamping and positioning device (56) and immediately prior to the welding of the second part (3) to the first part (2), the second part (3), whose mounting surface (14) is oriented perpendicular to the longitudinal axis (69) of its profile, in the case of deviation from the desired shape of its profile is shaped radially to the longitudinal axis (69) of its profile by means of the adjustable clamping tool (63) of the second clamping and positioning device (60) into the desired shape and is held in the latter, and wherein during or after this shaping of the part (3) into the desired shape, the said shaped second part (3) and the first part (2) are aligned relative to one another, pressed against one another with their corresponding mounting surfaces (7, 14) and then are joined together by beam welding at the joint (16).

91. Method according to claim 90, wherein the first and/or second part (3) is measured by means of a measuring device (64) for any deviation in shape, and the actual values of the dimensions according to the actual shape are determined, and the actual values of the dimensions (actual shape) are compared with the desired values of the dimensions (desired shape) and in the case of a deviation between the actual and desired values the first and/or second part (2, 3) is shaped by a specified amount (fixed value).

92. Method according to claim 90, wherein the first and/or second part (3) is measured by means of a measuring device (64) for deviation in shape and the actual values of the dimensions are determined according to the actual shape, and the actual values of the dimensions (actual shape) are compared with the desired values of the dimensions (desired shape), the deviation is established as the correction value and the correction value is supplied to a control unit (67), which depending on the correction value drives an actuator (65, 74, 74′, 74″) for the clamping tool (57, 57′, 57″, 63) of the first and/or second clamping and positioning device (56, 60), so that the deviation between the actual and desired values is adjusted/corrected.

93. Method according to claim 91, wherein the actual values of the dimensions of the first and/or second part (3) are determined by means of the optoelectronic measuring device (64) by non-contact methods.

94. Method according to claim 90, wherein the force of the clamping tool (57, 57′, 57″, 63) on the first and/or second part (2, 3) is set depending on the correction value and once the correction value has been adjusted and the first and/or second part (2, 3) has been shaped into the desired shape, the force of the clamping tool (57, 57′, 57″, 63) is kept constant on the first and/or second part (2, 3).

95. Method according to claim 90, wherein after the alignment and mutual pressing together of the parts (2, 3), the second part (3) is prefixed by welding points and afterwards is welded by at least one continuous weld (17) at the joint (16) to the first part (2).

96. Method according to claim 90, wherein during the shaping of the first and/or second part (3) from its actual shape into the desired shape the latter is shaped plastically.

97. Method according to claim 90, wherein during the shaping of the first and/or second part (3) from its actual shape into the desired shape the latter is shaped elastically.

98. Welding system for performing the method according to claim 90, which comprises a welding device (58), a first clamping and positioning device (56) with at least one clamping tool (57, 57′, 57″) for mounting, positioning and clamping a first part (2) against a second part (3), and a second clamping and positioning device (60) with at least one clamping tool (63) for mounting, positioning and clamping the second part (2) against the first part (2), a holder (59) or mounting one of the parts (2, 3) if necessary and a control (67), wherein at least one of the clamping tools (57, 57′, 57″, 63) of the clamping and positioning devices (56, 60) is designed for shaping the part (2, 3) mounted thereby in case of a deviation in shape into its desired shape as necessary, and is actively connected with at least one actuator (65, 74, 74′, 74″) which is connected in turn with the control (67) driving the latter.

99. Welding system according to claim 98, wherein the latter comprises a measuring device (64) for detecting the actual values of the dimensions of the first and/or second part (2, 3), which device is connected in turn to the control (67).

100. Welding system according to claim 99, wherein the measuring device (64) is formed by an optoelectronic or electromechanically operating measuring system.

101. Welding system according to claim 98, wherein the clamping tool (57, 57′, 57″, 63) is provided with a device for detecting the force exerted on the first and/or second part (2,3) for shaping the latter.

102. Welding system according to claim 98, wherein each clamping and positioning device (56, 60) is mounted on an adjusting device which comprises an actuator connected to the control (67).
